(19) United States
(12) Patent Application Publication
(10) Pub. No.: US 2023/0009792 A1
(43) Pub. Date: Jan. 12, 2023

(54) BATTERY

(71) Applicant: Panasonic Intellectual Property Management Co., Ltd., Osaka (JP)

(72) Inventors: KAZUHIRO MORIOKA, Osaka (JP); AKIRA KAWASE, Osaka (JP)

(21) Appl. No.: 17/933,501

(22) Filed: Sep. 20, 2022

Related U.S. Application Data
(63) Continuation of application No. PCT/JP2021/014565, filed on Apr. 6, 2021.

(30) Foreign Application Priority Data
Apr. 17, 2020 (JP) 2020-074156

(51) Int. Cl. H01M 50/451; H01M 10/0525; H01M 50/414

(52) U.S. Cl. CPC H01M 50/451; H01M 10/0525; H01M 50/414

(57) ABSTRACT

A battery includes an electrode layer, a counter-electrode layer placed opposite to the electrode layer, a solid electrolyte layer located between the electrode layer and the counter-electrode layer, and an insulating layer located between the electrode layer and the solid electrolyte layer. The electrode layer includes a collector and an electrode active material layer located between the collector and the solid electrolyte layer and between the collector and the insulating layer. The insulating layer is located at ends of the electrode active material layer in plan view. The insulating layer is located in a region where a length of the electrode active material layer from an outer periphery in plan view is less than or equal to 1 mm.

### BACKGROUND

### 1. Technical Field

The present disclosure relates to a battery.

### 2. Description of the Related Art

International Publication No. 2012/164642 and Japanese Unexamined Patent Application Publication No. 2016-207286 disclose a battery including an insulating member.

### SUMMARY

The conventional technology is required to improve the reliability of a battery. One non-limiting and exemplary embodiment provides a highly-reliable battery.

In one general aspect, the techniques disclosed here feature a battery including an electrode layer, a counter-electrode layer placed opposite to the electrode layer, a solid electrolyte layer located between the electrode layer and the counter-electrode layer, and an insulating layer located between the electrode layer and the solid electrolyte layer. The electrode layer includes a collector and an electrode active material layer located between the collector and the solid electrolyte layer and between the collector and the insulating layer. The insulating layer is located at ends of the electrode active material layer in plan view. The insulating layer is located in a region where a length of the electrode active material layer from an outer periphery in plan view is less than or equal to 1 mm.

The present disclosure makes it possible to provide a highly-reliable battery.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic top view showing an example of a battery according to Embodiment 1;

FIG. 2 is a cross-sectional view taken along line II-II in FIG. 1;

FIG. 3 is a schematic cross-sectional view showing an example of a battery according to a comparative example;

FIG. 4 is a schematic cross-sectional view showing another example of a battery according to the comparative example;

FIG. 5 is a flow chart for explaining a method for manufacturing a battery according to Embodiment 1;

FIG. 6A illustrates a schematic top view and a schematic cross-sectional view showing an example of a laminated combination of a collector, an electrode active material layer, and an insulating layer according to Embodiment 1;

FIG. 6B is a schematic top view showing another example of a laminated combination of a collector, an electrode active material layer, and an insulating layer according to Embodiment 1;

FIG. 6C illustrates a schematic top view and a schematic cross-sectional view showing another example of a laminated combination of a collector, an electrode active material layer, and an insulating layer according to Embodiment 1;

FIG. 7A is a schematic cross-sectional view showing an example of a laminated polar plate according to Embodiment 1;

FIG. 7B is a schematic cross-sectional view showing another example of a laminated polar plate according to Embodiment 1;

FIG. 7C is a schematic cross-sectional view showing another example of a laminated polar plate according to Embodiment 1;

FIG. 8 is a diagram for explaining a cutting step of the method for manufacturing a battery according to Embodiment 1;

FIG. 9 is a schematic cross-sectional view showing an example of a battery according to Modification 1 of Embodiment 1;

FIG. 10 is a schematic cross-sectional view showing another example of a battery according to Modification 1 of Embodiment 1;

FIG. 11 is a diagram for explaining a cutting step of a method for manufacturing a battery according to Modification 1 of Embodiment 1;

FIG. 12 is a schematic cross-sectional view showing an example of a battery according to Embodiment 2;

FIG. 13 is a schematic cross-sectional view showing another example of a battery according to Embodiment 2;

FIG. 14 is a flow chart for explaining a method for manufacturing a battery according to Embodiment 2;

FIG. 15 is a schematic cross-sectional view showing an example of a multi-layer polar plate according to Embodiment 2;

FIG. 16 is a schematic cross-sectional view showing an example of a laminated polar plate according to Modification 1 of Embodiment 2;

FIG. 17 is a schematic cross-sectional view showing an example of a multi-layer polar plate according to Modification 1 of Embodiment 2;

FIG. 18 is a schematic cross-sectional view showing another example of a laminated polar plate according to Modification 1 of Embodiment 2;

FIG. 19 is a schematic cross-sectional view showing another example of a laminated polar plate according to Modification 1 of Embodiment 2;

FIG. 20 is a schematic cross-sectional view showing an example of a battery according to Modification 1 of Embodiment 2;

FIG. 21 is a schematic cross-sectional view showing another example of a battery according to Modification 1 of Embodiment 2;

FIG. 22 is a schematic cross-sectional view showing an example of a battery according to Embodiment 3; and

FIG. 23 is a schematic cross-sectional view showing another example of a battery according to Embodiment 3.

### DETAILED DESCRIPTIONS

### Underlying Knowledge Forming Basis of the Present Disclosure

In a case where a battery such as an all-solid battery including a solid electrolyte layer containing a solid electrolyte is manufactured, it is common to make the area of a negative-electrode active material layer larger than the area of a positive-electrode active material layer. This is intended to stabilize the performance of the battery and improve the reliability of the battery by making the capacitance of the negative-electrode active material layer larger than the capacitance of the positive-electrode active material layer to suppress, for example, deposition of metal derived from metal ions not incorporated into the negative-electrode active material layer. Further, this is also intended to improve the reliability of the battery by suppressing the concentration of electric fields at ends of the negative-electrode active material layer to inhibit dendrite growth (deposition of metal) at the ends. Further, in a case where the area of the negative-electrode active material layer is made larger, the solid electrolyte layer, for example, is disposed around the positive-electrode active material layer, which is placed opposite to the negative-electrode active material layer. This prevents exposure of ends of the positive-electrode active material layer, thus enhancing the reliability also by making it hard for the positive-electrode active material layer and the solid electrolyte layer to delaminate.

However, it is difficult to manufacture a battery while precisely controlling the area of a positive-electrode active material layer and the area of a negative-electrode active material layer as just described. Further, for the purpose ensuring reliability, it is necessary to form the positive-electrode active material layer in consideration of the dimensional accuracy with which the positive-electrode active material layer is formed. This undesirably causes the positive-electrode active material layer to be small and causes the volume energy density of the battery to be low. Further, increasing the dimensional accuracy of the positive-electrode active material layer raises concern about an increase in the number of steps such as inspections and an increase in facility cost.

To address this problem, the present disclosure provides a highly-reliable battery. In particular, the present disclosure provides a highly-reliable battery with an increased volume energy density.

The following gives a brief description of an aspect of the present disclosure.

A battery according to an aspect of the present disclosure includes an electrode layer, a counter-electrode layer placed opposite to the electrode layer, a solid electrolyte layer located between the electrode layer and the counter-electrode layer, and an insulating layer located between the electrode layer and the solid electrolyte layer. The electrode layer includes a collector and an electrode active material layer located between the collector and the solid electrolyte layer and between the collector and the insulating layer. The insulating layer is located at ends of the electrode active material layer in plan view. The insulating layer is located in a region where a length of the electrode active material layer from an outer periphery in plan view is less than or equal to 1 mm.

In this way, a region where the electrode active material layer, the insulating layer, and the solid electrolyte layer are laminated in this order is present at the ends of the electrode active material layer in plan view. Therefore, even if the solid electrolyte layer delaminates at the ends of the electrode active material layer and the solid electrolyte layer, at which delamination tends to occur due to a heterojunction interface, exposure of the electrode active material layer is reduced. This makes it hard for damage, a short circuit, or other failures to occur due to contact between the electrode active material layer and another member. This makes it possible to enhance the reliability of the battery.

Further, in this way, a region where the presence of the insulating layer makes it hard for the electrode active material layer to function as an electrode can fall within a range of distances less than or equal to a certain distance from the outer periphery of the electrode active material layer. This makes it possible to increase the volume energy density of the battery.

Further, for example, a side surface of the insulating layer and a side surface of the electrode active material layer may be flush with each other.

Further, this makes it possible to manufacture the battery with the area of the insulating layer easily adjusted, for example, by collectively cutting the insulating layer and the electrode active material layer, as the side surface of the insulating layer and the side surface of the electrode active material layer are flush with each other. Therefore, although the presence of the insulating layer inhibits the electrode active material layer and the solid electrolyte layer from giving and receiving metal ions to and from each other and results in the formation of a region where the electrode active material layer hardly functions as an electrode, the region can be minimized by adjusting the area of the insulating layer. This makes it possible to increase the volume energy density of the battery.

Further, for example, the electrode layer may be a positive-electrode layer, and the counter-electrode layer may be a negative-electrode layer.

In this way, metal ions from a portion of the electrode active material layer that is in a region that overlaps the insulating layer in plan view, i.e. a portion of the positive-electrode active material layer that is in a region that overlaps the insulating layer in plan view, hardly reaches the solid electrolyte layer, so that the positive-electrode active material layer of that region hardly functions as an electrode. This brings about an effect of substantially reducing the area of the positive-electrode active material layer. As a result, the area of the positive-electrode active material layer tends to be substantially smaller than the area of the counter-electrode active material layer of the negative-electrode layer, i.e. the negative-electrode active material layer. Therefore, the capacitance of the negative-electrode active material layer tends to be larger than the capacitance of the positive-electrode active material layer. This suppresses deposition of metal derived from metal ions not incorporated into the negative-electrode active material layer, making it possible to further enhance the reliability of the battery.

Further, for example, the insulating layer may contain resin.

This makes it possible to enhance the bondability between the insulating layer and the electrode active material layer and between the insulating layer and the solid electrolyte layer through an anchoring effect by which the resin contained in the insulating layer penetrates into the electrode active material layer and the solid electrolyte layer, making it possible to inhibit the insulating layer from delaminating from the electrode active material layer or the solid electrolyte layer.

Further, for example, the insulating layer may contain a metal oxide.

This makes the insulating layer hard. Therefore, even in a case where the insulating layer is thinly formed at the time of manufacture of the battery, the insulating layer hardly deforms in being laminated on another layer. The insulating layer thus formed can be a thin layer of uniform thickness.

Further, for example, a thickness of the insulating layer may be less than or equal to 5 μm. Further, for example, the thickness of the insulating layer may be less than or equal to 2 μm.

This reduces the thickness of the insulating layer located between the electrode active material layer and the solid electrolyte layer. This makes it possible to, even in a case where the layers of the battery laminated over the collector are subjected to a high-pressure press process for the purpose of, for example, increasing the volume energy density of the battery, lessen the influence of the insulating layer on the pressing of the layers, making it easy for the layers such as the electrode active material layer to be uniformly compressed. This results in making it possible to reduce the possibility of, for example, the layers delaminating by being non-uniformly compressed. This makes it possible to achieve a highly-reliable battery with an increased energy density.

Further, for example, the counter-electrode layer may include a counter-electrode active material layer placed opposite to the electrode active material layer, and respective side surfaces of the solid electrolyte layer, the collector, the electrode active material layer, the counter-electrode active material layer, and the insulating layer may be exposed.

In this way, layers that contribute to the charge-discharge performance of the battery are present to ends of the battery. This makes it possible to increase the volume energy density of the battery.

Further, for example, a side surface of the electrode layer, a side surface of the counter-electrode layer, and a side surface of the insulating layer may be flush with one another.

This makes the side surfaces of the layers of the battery free from steps or asperities. This prevents a space that does not contribute to the charge-discharge performance of the battery from being formed by the presence of asperities, making it possible to reduce substantive deterioration of the energy density of the battery. This makes it possible to increase the volume energy density of the battery.

Further, for example, the counter-electrode layer may include a counter-electrode active material layer placed opposite to the electrode active material layer, and the electrode active material layer and the counter-electrode active material layer may be identical in shape and position to each other in plan view.

This makes it possible to reduce the difference in capacitance between the counter-electrode active material layer and the electrode active material layer, thus making it possible to maximize the capacitance of the counter-electrode active material layer or the electrode active material layer.

Further, in a case where the electrode layer is a positive-electrode layer and the counter-electrode layer is a negative-electrode layer, a portion of the positive-electrode active material layer placed opposite to the ends of the negative-electrode active material layer hardly functions as an electrode, as the positive-electrode active material layer and the negative-electrode active material layer are identical in shape and position to each other in plan view and the insulating layer is located at the ends of the positive-electrode active material layer in plan view. As a result, the concentration of electric fields at the ends of the negative-electrode active material layer is suppressed, so that dendrite growth at the ends is inhibited. This brings about improvement in reliability of the battery.

Further, for example, a side surface of the battery may be inclined in such a direction with respect to a direction of laminating that an area of the counter-electrode layer is larger than an area of the electrode layer in plan view.

This causes the side surface of the solid electrolyte layer to be larger than in a case where the side surface is not inclined, as the side surface of the solid electrolyte layer too is inclined with respect to the direction of laminating on the side surface of the battery. This results in an increase in the distance between the electrode layer and the counter-electrode layer, which are separated from each other by the solid electrolyte layer, on the side surface of the battery. This makes it hard for the electrode layer and the counter-electrode layer to be in contact with each other, reducing the risk of a short circuit.

Further, for example, a side surface of the battery may be a cut surface.

In this way, since the side surface, which is to become an end of the battery, is formed by cutting, adjusting the area of the insulating layer according to cutting position makes it possible to reduce the area of a region where the presence of the insulating layer makes it hard for the electrode active material layer to function as an electrode, making it possible to increase the volume energy density of the battery. Further, since the side surface of the battery is a cut surface, the side surface of the electrode layer, the side surface of the counter-electrode layer, the side surface of the solid electrolyte layer, and the side surface of the insulating layer can be easily made flush with one another.

Further, for example, a shape of the cut surface may be rectangular or trapezoidal.

This causes the cut surface to have linearly-shaped ends. This prevents a space that does not contribute to the charge-discharge performance of the battery from being formed by non-linear ends, making it possible to reduce substantive deterioration of the energy density of the battery. This makes it possible to increase the energy density of the battery.

Further, for example, the insulating layer may be in a shape of a frame located on an outer periphery of the electrode active material layer in plan view.

This brings about an effect of providing the insulating layer in any place on the outer periphery of the electrode active material layer in plan view.

Further, for example, the solid electrolyte layer may contain a solid electrolyte having lithium-ion conductivity.

This makes it possible to enhance the battery reliability of a lithium-ion battery containing a solid electrolyte.

The following describes embodiments in concrete terms with reference to the drawings.

It should be noted that the embodiments to be described below each illustrate a comprehensive and specific example. The numerical values, shapes, materials, constituent elements, placement and topology of constituent elements, or other features that are shown in the following embodiments are just a few examples and are not intended to limit the present disclosure.

Further, terms such as “parallel” and “flush” used herein to show the way in which elements are interrelated, terms such as “flat” and “rectangular” used herein to show the shape of an element, and ranges of numerical values used herein are not expressions that represent only exact meanings but expressions that are meant to also encompass substantially equivalent ranges, e.g. differences of approximately several percent.

Further, the drawings are not necessarily strict illustrations. In the drawings, substantially the same components are given the same reference signs, and a repeated description may be omitted or simplified.

Further, in the present specification and drawings, the x axis, the y axis, and the z axis represent the three axes of a three-dimensional orthogonal coordinate system. In each of the embodiments, the z-axis direction is a direction of laminating of a battery. Further, a positive direction parallel with the z axis is upward in the z-axis direction, and a negative direction parallel with the z axis is downward in the z-axis direction. Further, the term “plan view” used herein means a case where the battery is seen from an angle parallel with the z axis. Further, the term “thickness” used herein means the length of each layer in the direction of laminating.

Further, the terms “above” and “below” in the configuration of a battery used herein do not refer to an upward direction (upward in a vertical direction) and a downward direction (downward in a vertical direction) in absolute space recognition, but are used as terms that are defined by a relative positional relationship on the basis of an order of laminating in a laminating configuration. Further, the terms “above” and “below” are applied not only in a case where two constituent elements are placed at a spacing from each other with another constituent element present between the two constituent elements, but also in a case where two constituent elements touch each other by being placed in close contact with each other.

### Embodiment 1

The following describes a battery according to Embodiment 1. The battery according to Embodiment 1 is a single cell including one electrode active material layer and one counter-electrode active material layer.

### Configuration

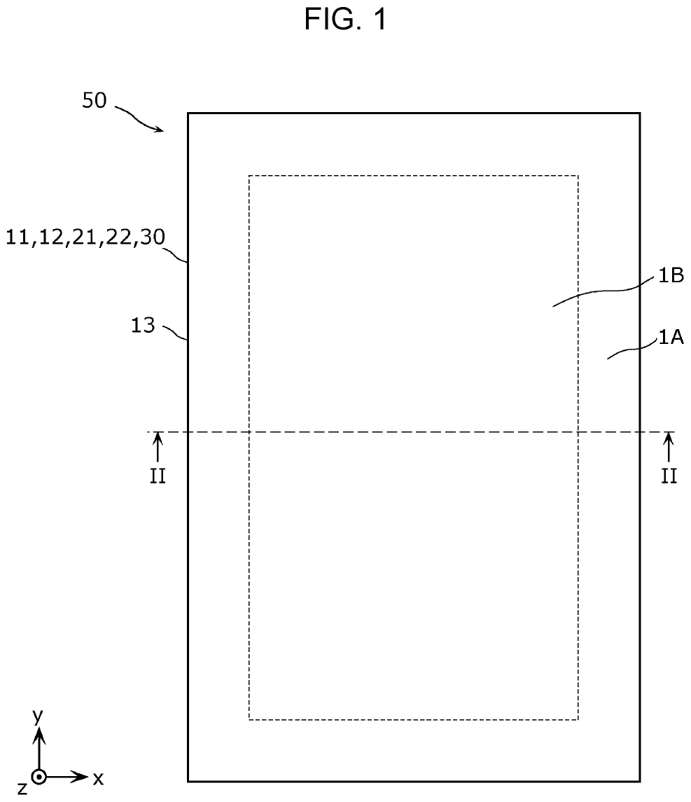

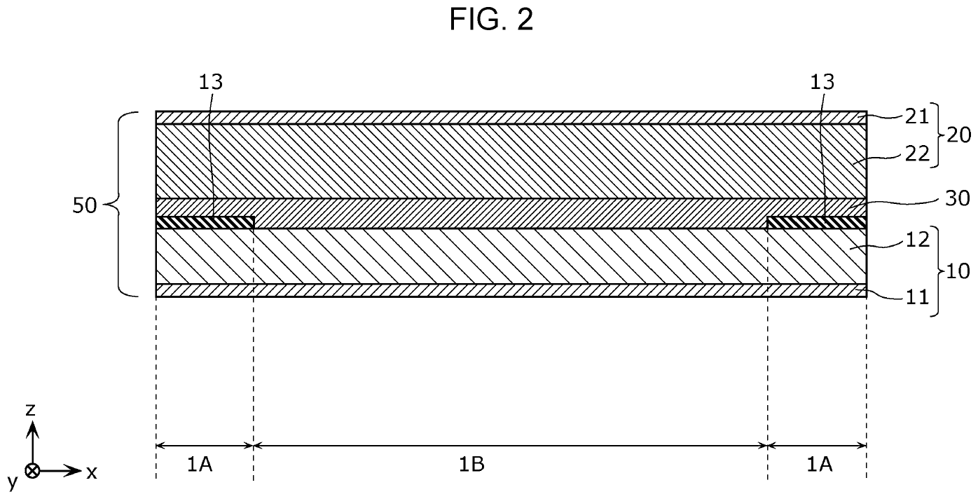

First, a configuration of the battery according to Embodiment 1 is described with reference to the drawings. FIG. 1 is a schematic top view showing an example of a battery according to the present embodiment. FIG. 2 is a cross-sectional view as taken along line II-II in FIG. 1.

As shown in FIGS. 1 and 2, the battery 50 according to the present embodiment includes an electrode layer 10, a counter-electrode layer 20 placed opposite to the electrode layer 10, and a solid electrolyte layer 30 located between the electrode layer 10 and the counter-electrode layer 20. That is, the battery 50 has a structure in which the electrode layer 10, the solid electrolyte layer 30, and the counter-electrode layer 20 are laminated in this order. Further, the battery 50 further includes an insulating layer 13 located between the electrode layer 10 and the solid electrolyte layer 30.

The electrode layer 10 includes a collector 11, an electrode active material layer 12 located between the collector 11 and the solid electrolyte layer 30 and between the collector 11 and the insulating layer 13. The collector 11 and the electrode active material layer 12 are identical in shape and position to each other in plan view.

The counter-electrode layer 20 includes a collector 21 and a counter-electrode active material layer 22 located between the collector 21 and the solid electrolyte layer 30.

The battery 50 is for example an all-solid battery. A side surface of the battery 50 is parallel with the direction of laminating. Further, the side surface of the battery 50 is a flat surface. In other words, a side surface of the electrode layer 10, a side surface of the counter-electrode layer 20, a side surface of the solid electrolyte layer 30, and a side surface of the insulating layer 13 are in a stepless state, and are located at the same flat surface. That is, the side surface of the electrode layer 10, the side surface of the counter-electrode layer 20, the side surface of the solid electrolyte layer 30, and the side surface of the insulating layer 13 are flush with one another. It should be noted that the term “side surface” refers to a surface of each constituent element of the battery 50 that extends from an end of a principal surface in a direction intersecting the principal surface, with the principal surface being a flat surface that is perpendicular to the direction of laminating. Further, at an end of the electrode layer 10 in a direction perpendicular to the direction of laminating, a side surface of the insulating layer 13, a side surface of the electrode active material 12, and a side surface of the collector 11 are flush with one another. Further, at an end of the counter-electrode layer 20 in a direction perpendicular to the direction of laminating, a side surface of the counter-electrode active material layer 22 and a side surface of the collector 21 are flush with each other. That is, at an end of the battery 50 in a direction perpendicular to the direction of laminating, the respective side surfaces of the collector 11, the electrode active material layer 12, the insulating layer 13, the solid electrolyte layer 30, the counter-electrode active material layer 22, and the collector 21 are flush with one another, and form the same flat surface. This makes the side surfaces of the layers of the battery 50 free from steps or asperities, thus preventing the formation of a space that does not function as a battery due to asperities and bringing about improvement in substantive volume energy density of the battery 50. Further, since the side surfaces of the layers can be made flush with one another, for example, by collectively cutting the layers, the battery 50 can be manufactured with the area of the insulating layer 13 easily adjusted.

The side surface of the battery 50 is for example a cut surface. Specifically, the side surface of the battery 50 is a surface formed by being cut with the edge of a cutter or other tools for cutting and, for example, is a surface having traces of cutting such as fine grooves. Since the battery 50 has a cut surface formed by being thus cut, the location to form the insulating layer 13 can be adjusted. This makes it possible to reduce the area of a portion (i.e. a portion in which the insulating layer 13 is formed, which will be described in detail later) that does not contribute to the charge-discharge performance of the battery 50, making it possible to improve the volume energy density. Further, since the side surface of the battery 50 is a cut surface, the side surface of the electrode layer 10, the side surface of the counter-electrode layer 20, the side surface of the solid electrolyte layer 30, and the side surface of the insulating layer 13 can be easily made flush with one another. It should be noted that the traces of cutting may be smoothed by polishing. The cut surface is not limited to particular shapes; however, in the case of the battery 50, the cut surface is rectangular.

Further, in the battery 50, the respective side surfaces of the collector 11, the insulating layer 13, the electrode active material layer 12, the solid electrolyte layer 30, the counter-electrode active material layer 22, and the collector 21 are exposed. This brings about improvement in volume energy density of the battery 50, as layers that contribute to the charge-discharge performance of the battery 50 are present to ends of the battery 50.

Further, in the battery 50, the collector 11, the electrode active material layer 12, the solid electrolyte layer 30, the counter-electrode active material layer 22, and the collector 21 are identical in shape and position to one another in plan view. The shapes of the collector 11, the electrode active material layer 12, the solid electrolyte layer 30, the counter-electrode active material layer 22, and the collector 21 in plan view are rectangles, but are not limited to particular shapes and may be circles, ellipses, polygons, or other shapes.

The collector 11 is in contact with a lower surface of the electrode active material layer 12, and covers the lower surface of the electrode active material layer 12. The thickness of the collector 11 is for example greater than or equal to 5 μm and less than or equal to 100 μm.

As a material of the collector 11, a generally known material may be used. As the collector 11, a foil-like body, a plate-like body, a net-like body, or other bodies composed of, for example, copper, aluminum, nickel, iron, stainless steel, platinum, gold, an alloy of two or more types thereof, or other substances are used.

The electrode active material layer 12 is laminated above the collector 11 so as to cover the collector 11. The lower surface of the electrode active material layer 12 is in contact with the collector 11. At ends of the electrode active material layer 12 in plan view, the insulating layer 13 is laminated. An upper surface of the electrode active material layer 12 is in contact with the insulating layer 13 and the solid electrolyte layer 30. The electrode active material layer 12 and the counter-electrode active material layer 22 face each other across the solid electrolyte layer 30. The electrode active material layer 12 has a region that does not overlap the insulating layer 13 in plan view. Further, the electrode active material layer 12 and the counter-electrode active material layer 22 are identical in shape and position to each other in plan view. The thickness of the electrode active material layer 12 is for example greater than or equal to 5 μm and less than or equal to 300 μm. A material for use in the electrode active material layer 12 will be described later.

The insulating layer 13 is a layer having insulating properties against electrons and metal ions. The insulating layer 13 is located between the electrode active material layer 12 and the solid electrolyte layer 30. Further, the insulating layer 13 is located at the ends of the electrode active material layer 12 in plan view. An upper surface of the insulating layer 13 and an inner side surface of the insulating layer 13 in plan view are in contact with the solid electrolyte layer 30. The insulating layer 13 is in contact with the electrode active material layer 12 at the ends of the electrode active material layer 12 in plan view. The side surface of the insulating layer 13 and the side surface of the electrode active material 12 are flush with each other. The lower surface of the insulating layer 13 is in contact with the electrode active material layer 12. Further, the insulating layer 13 overlaps the counter-electrode active material layer 22 in plan view.

In the illustrated example, the insulating layer 13 is in the shape of a frame located on the outer periphery of the electrode active material layer 12 in plan view. That is, the insulating layer 13 is located between the electrode active material layer 12 and the solid electrolyte layer 30 at all ends of the electrode active material layer 12 in directions perpendicular to the direction of laminating.

The insulating layer 13 contains, for example, at least one of resin and a metal oxide. Examples of the resin include silicone resin, epoxy resin, acrylic resin, and polyimide resin. The resin may be thermosetting resin or ultraviolet-curable resin. The inclusion of the resin by the insulating layer 13 makes it possible to enhance the bondability between the insulating layer 13 and the electrode active material layer 12 and between the insulating layer 13 and the solid electrolyte layer 30, for example, through an anchoring effect by which the resin penetrates into the electrode active material layer 12 and the solid electrolyte layer 30. Examples of the metal oxide include silicon oxide, titanium oxide, and aluminum oxide. The inclusion of the metal oxide by the insulating layer 13 makes the insulating layer 13 hard. Therefore, even in a case where the insulating layer 13 is thinly formed at the time of manufacture of the battery 50, the insulating layer 13 hardly deforms in being laminated on another layer. The insulating layer 13 thus formed can be a thin layer of uniform thickness.

The thickness of the insulating layer 13 is thinner than the thicknesses of the electrode active material layer 12 and the solid electrolyte layer 30 and, for example, is sufficiently thin in comparison with the thicknesses of the electrode active material layer 12 and the solid electrolyte layer 30. By being thinner than the thicknesses of the electrode active material layer 12 and the solid electrolyte layer 30, the thickness of the insulating layer 13 makes it possible to lessen the influence of the insulating layer 13 even in a case where a high-pressure press process is performed at the time of laminating of the electrode active material layer 12, the solid electrolyte layer 30, or other layers, thus making it easy for the electrode active material layer 12, the solid electrolyte layer 30, or other layers to be uniformly compressed. Even in a case where a high-pressure press process is performed at the time of laminating of the electrode active material layer 12, the solid electrolyte layer 30, or other layers, the thickness of the insulating layer 13 is for example less than or equal to 5 μm from the point of view of making it easy for the electrode active material layer 12, the solid electrolyte layer 30, or other layers to be uniformly compressed. The thickness of the insulating layer 13 may be less than or equal to 2 μm or may be less than or equal to 1 μm from the point of view of battery characteristics. The insulating layer 13 is for example completely insulative, however, depending on battery characteristics required, the insulating layer 13 may slightly have electrical conductivity due to a constituent material and thickness of the insulating layer 13.

Further, the insulating layer 13 is located in a region where a length of the electrode active material layer 12 from the outer periphery, for example, in plan view is less than or equal to 1 mm from the point of view of an effective area that contributes to power generation, i.e. from the point of view of volume energy density. Further, a width of the insulating layer 13 in a case where the insulating layer 13 is formed in the shape of a frame or a line or other shapes is for example smaller than or equal to 1 mm, and may be less than or equal to 0.5 mm or may be less than or equal to 0.1 mm from the point of view of volume energy density. The width of the insulating layer 13 is changed, for example, depending on battery characteristics required.

The collector 21 is in contact with an upper surface of the counter-electrode active material layer 22, and covers the upper surface of the counter-electrode active material layer 22. The thickness of the collector 21 is for example greater than or equal to 5 μm and less than or equal to 100 μm. As a material of the collector 21, the material of the aforementioned collector 11 may be used.

The counter-electrode active material layer 22 is laminated on top of the solid electrolyte layer 30, and is placed opposite to the electrode active material layer 12. The upper surface of the counter-electrode active material layer 22 is in contact with the collector 21. The thickness of the counter-electrode active material layer 22 is for example greater than or equal to 5 μm and less than or equal to 300 μm. A material for use in the counter-electrode active material layer 22 will be described later.

The solid electrolyte layer 30 is located between the electrode active material layer 12 and the counter-electrode active material layer 22. The solid electrolyte layer 30 is laminated above the electrode active material layer 12 so as to cover the insulating layer 13, which is on top of the electrode active material layer 12. The upper surface of the solid electrolyte layer 30 is in contact with the counter-electrode active material layer 22. A lower surface of the solid electrolyte layer 30 is in contact with the insulating layer 13 and the electrode active material layer 12. The thickness of the solid electrolyte layer 30 is for example greater than or equal to 5 μm and less than or equal to 150 μm.

The solid electrolyte layer 30 contains at least a solid electrolyte and, if necessary, may contain a binder material. The solid electrolyte layer 30 may contain a solid electrolyte having lithium-ion conductivity.

As the solid electrolyte, a generally known metal-ion-conducting material such as a lithium-ion conductor, a sodium ion conductor, or a magnesium ion conductor may be used. As the solid electrolyte, for example, a solid electrolyte material such as a sulfide solid electrolyte, a halogenated solid electrolyte, or an oxide solid electrolyte is used. In the case of a material that is able to conduct lithium ions, for example, a synthetic substance composed of lithium sulfide (Li₂S) and diphosphorous pentasulfide (P₂S₅) is used as the sulfide solid electrolyte. Further, as the sulfide solid electrolyte, a sulfide such as Li₂S—SiS₂, Li₂S—B₂S₃, or Li₂S—GeS₂ may be used, or a sulfide obtained by adding at least one type of Li₃N, LiCl, LiBr, Li₃PO₄, or Li₄SiO₄ as an additive to the aforementioned sulfide may be used.

In the case of a material that is able to conduct lithium ions, for example, Li₇La₃Zr₂O₁₂ (LLZ), Li_{1.3}Al_{0.3}Ti_{1.7}(PO₄)₃ (LATP), (La,Li)TiO₃ (LLTO), or other substances are used as the oxide solid electrolyte.

As the binder material, for example, elastomers are used, or an organic compound such as polyvinylidene fluoride, acrylic resin, or cellulose resin may be used.

In the present embodiment, one of the electrode layer 10, which includes the electrode active material layer 12, and the counter-electrode layer 20, which includes the counter-electrode active material layer 22, is a positive-electrode layer including a positive-electrode active material layer, and the other is a negative-electrode layer including a negative-electrode active material layer.

The positive-electrode active material layer contains at least a positive-electrode active material and, if necessary, may contain at least one of a solid electrolyte, a conductive auxiliary agent, and a binder material.

As the positive-electrode active material, a generally known material that is capable of occlusion and ejection (insertion and desorption or dissolution and deposition) of lithium ions, sodium ions, or magnesium ions may be used. In the case of a material that is capable of desorption and insertion of lithium ions, for example, a lithium cobalt oxide complex oxide (LCO), a lithium nickel oxide complex oxide (LNO), a lithium manganese oxide complex oxide (LMO), a lithium-manganese-nickel complex oxide (LMNO), a lithium-manganese-cobalt complex oxide (LMCO), a lithium-nickel-cobalt complex oxide (LNCO), a lithium-nickel-manganese-cobalt complex oxide (LNMCO), or other substances are used as the positive-electrode active material.

As the solid electrolyte, the aforementioned solid electrolyte material may be used. Further, as the conductive auxiliary agent, for example, a conducting material such as acetylene black, carbon black, graphite, or carbon fiber is used. Further, as the binder material, the aforementioned binder material may be used.

The negative-electrode active material layer contains at least a negative-electrode active material and, if necessary, may contain at least one of a solid electrolyte, a conductive auxiliary agent, and a binder material similar to that of the positive-electrode active material layer.

As the negative-electrode active material, a generally known material that is capable of occlusion and ejection (insertion and desorption or dissolution and deposition) of lithium ions, sodium ions, or magnesium ions may be used. In the case of a material that is capable of desorption and insertion of lithium ions, for example, a carbon material such as natural graphite, synthetic graphite, graphite carbon fiber, or resin heat-treated carbon, metal lithium, a lithium alloy, an oxide of lithium and a transition metal element, or other substances are used as the negative-electrode active material.

In the case of manufacture of a battery, it is common, as mentioned above, to make the area of a negative-electrode active material layer larger than the area of a positive-electrode active material layer in plan view for the purpose of improving reliability. Furthermore, disposing ends of the negative-electrode active material layer further toward the outside than ends of the positive-electrode active material layer makes it possible to suppress the concentration of electric fields at the ends of the negative-electrode active material layer to inhibit dendrite growth (deposition of metal).

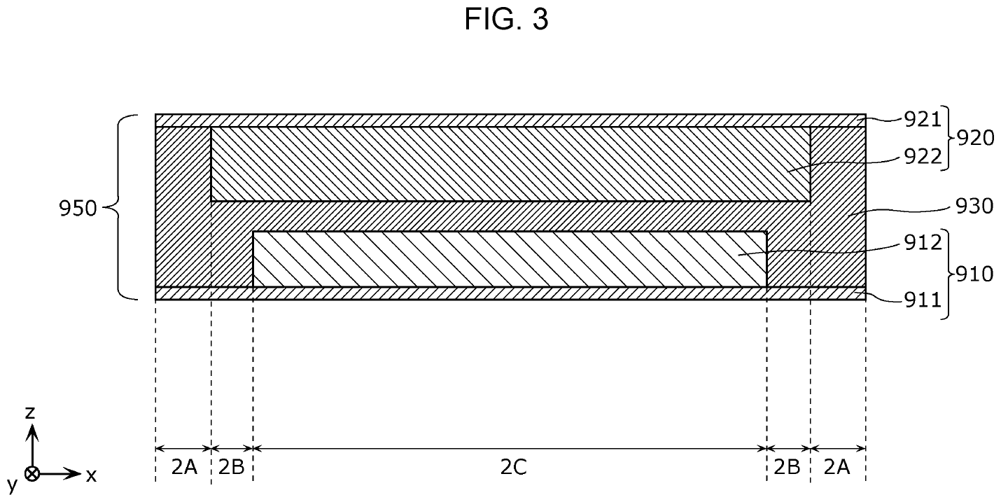

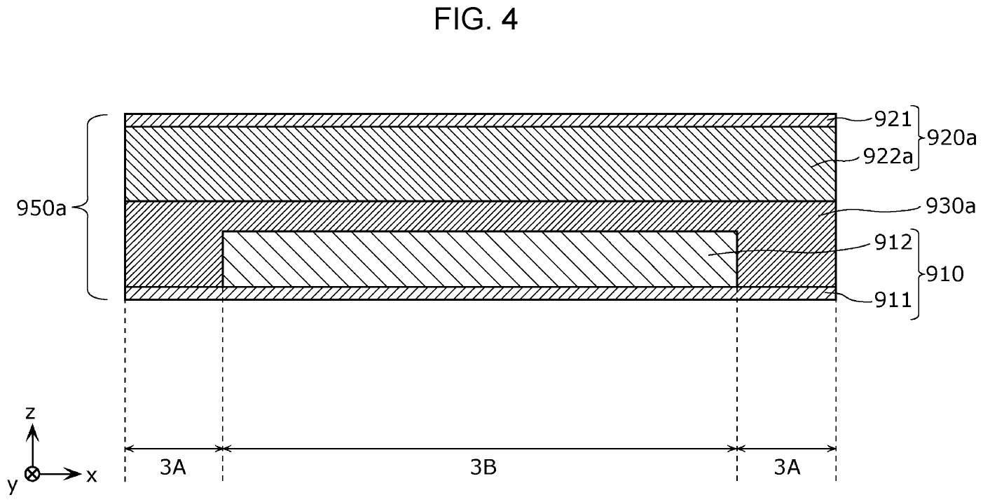

The following describes batteries 950 and 950a according to a comparative example in which the area of a negative-electrode active material layer is larger than the area of a positive-electrode active material layer in plan view. FIGS. 3 and 4 are schematic cross-sectional views showing examples of the batteries according to the comparative example.

As shown in FIG. 3, the battery 950 includes a positive-electrode layer 910, a negative-electrode layer 920, and a solid electrolyte layer 930 located between the positive-electrode layer 910 and the negative-electrode layer 920. The positive-electrode layer 910 includes a collector 911 and a positive-electrode active material layer 912 located between the collector 911 and the solid electrolyte layer 930. The negative-electrode layer 920 includes a collector 921 and a negative-electrode active material layer 922 located between the collector 921 and the solid electrolyte layer 930. The solid electrolyte layer 930 covers side surfaces of the positive-electrode active material layer 912 and the negative-electrode active material layer 922, and is in contact with the collector 911 and the collector 921. In a plan view of the battery 950, the area of the negative-electrode active material layer 922 is larger than the area of the positive-electrode active material layer 912, and ends of the negative-electrode active material layer 922 are located further toward the outside than ends of the positive-electrode active material layer 912. Thus, in the battery 950, deposition of metal is suppressed by making the area of the negative-electrode active material layer 922 is larger than the area of the positive-electrode active material layer 912. Further, the presence of the solid electrolyte layer 930 at ends of the battery 950 reduces exposure of the positive-electrode active material layer 912 and the negative-electrode active material layer 922 even in a case where the collector 911 and the collector 921 delaminate from the ends.

A region 2C where the positive-electrode active material layer 912 and the negative-electrode active material layer 922 are present functions as a battery. Meanwhile, a region 2A where neither the positive-electrode active material layer 912 nor the negative-electrode active material layer 922 is present does not function as a battery. Further, a region 2B where the negative-electrode active material layer 922 is present but the positive-electrode active material layer 912 is not present does not function as a battery, either. The region 2B is a region that is equivalent to the difference in area between the positive-electrode active material layer 912 and the negative-electrode active material layer 922. As the region 2B and the region 2A become wider in plan view, the proportion of regions in the battery 950 that do not contribute to power generation increases, with the result that the volume energy density of the battery 950 decreases. Meanwhile, as the region 2B becomes narrower in plan view, higher alignment accuracy is required in manufacturing steps such as steps of laminating the respective layers, and the higher-accuracy requirements entail concern about an increase in the number of steps such as inspections and an increase in facility cost.

Further, the regions 2A, 2B, and 2C differ from one another in type and number of layers other than the collectors 911 and 921 that are present in a thickness direction. That is, in the region 2A, only one layer, namely the solid electrolyte layer 930, is present. In the region 2B, two layers, namely the negative-electrode active material layer 922 and the solid electrolyte layer 930, are present. In the region 2C, three layers, namely the positive-electrode active material layer 912, the negative-electrode active material layer 922, and the solid electrolyte layer 930, are present. In the case of an all-solid battery composed of powder materials, manufacturing steps may include a high-pressure press process to form a favorable interface between the powder materials (e.g. an interface with high bondability between the powder materials and with low grain boundary resistivity), i.e. to improve the reliability of the battery and improve the volume energy density by being highly filled. At this point in time, the regions 2A, 2B, and 2C differ in type and number of layers that constitute the regions, and the layers differ in compressibility from one another. This raises concern that when the whole battery 950 is pressed, the regions may differ in degree of compression from one another or may not be uniformly compressed. For example, there is concern that the regions 2A and 2B may be less sufficiently compressed than the region 2C and may suffer from reduced reliability such as the delamination of the layers.

That is, the battery 950 is undesirably hard to easily manufacture and insufficient in improvement of reliability. Further, since the region 2A, whose sole through-thickness layer is the solid electrolyte layer 930, is a portion that does not particularly contribute to the basic charge-discharge performance of the battery, it is preferable, from the point of view of improving the volume energy density, that the region 2A be small.

Further, the battery 950 shown in FIG. 4 includes a positive-electrode layer 910a having a collector 911a and a positive-electrode active material layer 912a, a negative-electrode layer 920a having a collector 921a and a negative-electrode active material layer 922a, and a solid electrolyte layer 930a. The battery 950a differs from the battery 950 in that the solid electrolyte layer 930a does not cover a side surface of the negative-electrode active material layer 922a. The battery 950a does not have a region, such as the region 2A, where neither the positive-electrode active material layer 912 nor the negative-electrode active material layer 922 is present, but has a region 3A where the positive-electrode active material layer 912a is not present. Therefore, the region 3A does not contribute to power generation, and a problem similar to that which arises in the region 2B arises in the region 3A of the battery 950a too.

Meanwhile, as mentioned above, the battery 50 includes an electrode layer 10, a counter-electrode layer 20 placed opposite to the electrode layer 10, and a solid electrolyte layer 30 located between the electrode layer 10 and the counter-electrode layer 20. The battery 50 further includes an insulating layer 13 located between the electrode layer 10 and the solid electrolyte layer 30. The electrode layer 10 includes a collector 11 and an electrode active material layer 12 located between the collector 11 and the solid electrolyte layer 30 and between the collector 11 and the insulating layer 13. The electrode active material layer 12 has a region that does not overlap the insulating layer 13 in plan view. The insulating layer 13 is located at ends of the electrode active material layer 12 in plan view. A side surface of the insulating layer 13 and a side surface of the electrode active material 12 are flush with each other. Furthermore, the respective side surfaces of the collector 11, the electrode active material layer 12, the insulating layer 13, the solid electrolyte layer 30, the counter-electrode active material layer 22, and the collector 21 are flush with one another.

For this reason, even if the solid electrolyte layer 30 delaminates at the ends of the electrode active material layer 12 and the solid electrolyte layer 30, at which delamination tends to occur, exposure of the electrode active material layer 12 is reduced, as the insulating layer 13 is present between the electrode active material layer 12 and the solid electrolyte layer 30, so that it becomes hard for damage, a short circuit, or other failures to occur due to contact between the electrode active material layer 12 and another member. This brings about improvement in reliability of the battery 50.

Since the respective side surfaces of the collector 11, the insulating layer 13, the electrode active material layer 12, the solid electrolyte layer 30, the counter-electrode active material layer 22, and the collector 21 are flush with one another, the battery 50 can be manufactured with the area of the insulating layer 13 easily adjusted, for example, by collectively cutting the layers. Therefore, although the presence of the insulating layer 13 inhibits the electrode active material layer 12 and the solid electrolyte layer 30 from giving and receiving metal ions to and from each other and results in the formation of a region where the electrode active material layer 12 hardly functions as an electrode, the region can be minimized by adjusting the area of the insulating layer 13. This makes it possible to increase the volume energy density of the battery.

Further, since the insulating layer 13 is located between t the electrode active material layer 12 and the solid electrolyte layer 30, the electrode active material layer 12 is also present under the insulating layer 13. Therefore, even in a case where a high-pressure press process is performed, all regions are more easily uniformly compressed than, for example, in a case where a solid electrolyte layer is present on a side surface of an electrode active material layer as in the case of a battery according to the aforementioned comparative example. This makes it hard for the layers of the battery 50 to delaminate and makes it possible to improve the reliability and volume energy density of the battery 50 through a high-pressure press process.

Further, in the battery 50, for example, the electrode layer 10, which includes the electrode active material layer 12, is a positive-electrode layer including a positive-electrode active material layer, and the counter-electrode layer 20, which includes the counter-electrode active material layer 22, is a negative-electrode layer including a negative-electrode active material layer. In this case, metal ions from the positive-electrode active material layer (electrode active material layer 12), which is in contact with the insulating layer 13, hardly reach the solid electrolyte layer 30, so that a portion of the positive-electrode active material layer that is in a region 1A shown in FIGS. 1 and 2 hardly functions as an electrode. Meanwhile, a portion of the positive-electrode active material layer that is in a region 1B functions as an electrode. Therefore, in the battery 50, the region 1A hardly functions as a battery, and the region 1B functions as a battery. In the battery 50, although the areas of the positive-electrode active material layer and the negative-electrode active material layer (counter-electrode active material layer 22) in plan view are equal, an effect of reducing the area of the positive-electrode active material layer in plan view is substantially brought about, as the portion of the positive-electrode active material layer that is in the region 1A hardly functions as an electrode. That is, in the battery 50, deposition of metal is suppressed even when the areas of the positive-electrode active material layer and the negative-electrode active material layer in plan view are equal.

Further, since the positive-electrode active material layer and the negative-electrode active material layer are identical in shape and position to each other in plan view and the insulating layer 13 is located at the ends of the positive-electrode active material layer (electrode active material layer 12) in plan view, a portion of the positive-electrode active material layer placed opposite to the ends of the negative-electrode active material layer hardly functions as an electrode. As a result, the concentration of electric fields at the ends of the negative-electrode active material layer is suppressed, so that dendrite growth at the ends is inhibited. This brings about improvement in reliability of the battery 50.

Furthermore, at the time of manufacture of the battery 50, it is not necessary to form the positive-electrode active material layer or the negative-electrode active material layer with high position and area accuracy, as the substantive area of the positive-electrode active material can be adjusted by the insulating layer 13. This makes it possible to easily manufacture the battery 50. For example, the battery 50 is easily manufactured, for example, by cutting, in a region including the insulating layer 13, a laminated body obtained by laminating the positive-electrode layer (electrode layer 10), the insulating layer 13, the solid electrolyte layer 30, and the negative-electrode layer (counter-electrode layer 20).

### Manufacturing Method

The following describes a method for manufacturing a battery according to the present embodiment. It should be noted that the following method for manufacturing a battery 50 is just an example, and the method for manufacturing a battery 50 is not limited to the following example.

The method for manufacturing a battery 50 includes a first laminating step, a second laminating step, a cutting step, and a third laminating step. The following describes each of the steps in detail.

### (1) First Laminating Step

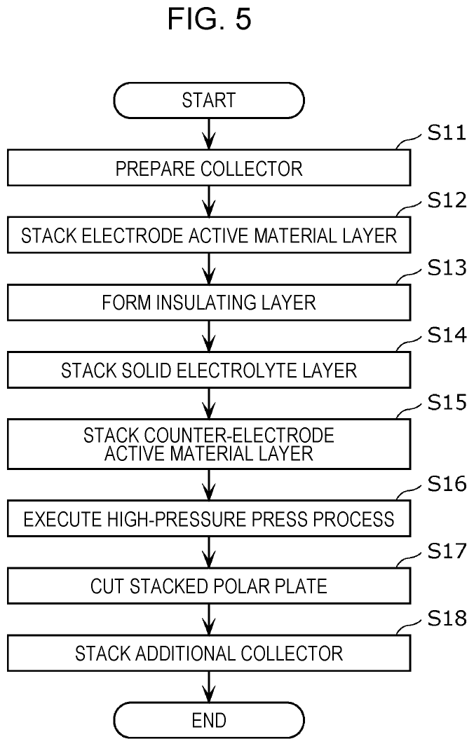

First, the first laminating step is described. FIG. 5 is a flow chart for explaining a method for manufacturing a battery according to the present embodiment.

In the first laminating step, an insulating layer 13 is laminated on a surface of an electrode active material layer 12 that faces away from a collector 11, with the electrode active material layer 12 laminated on at least one surface of the collector 11. Specifically, first, the collector 11 is prepared (step S11 of FIG. 5). Then, the electrode active material layer 12 is laminated on at least one surface of the collector 11 thus prepared (step S12 of FIG. 5). For example, the electrode active material layer 12 is laminated on the collector 11 by forming the electrode active material layer 12 on an upper surface of the collector 11. Then, the insulating layer 13 is laminated on a surface of the electrode active material layer 12 that faces away from the collector 11 (step S13 of FIG. 5).

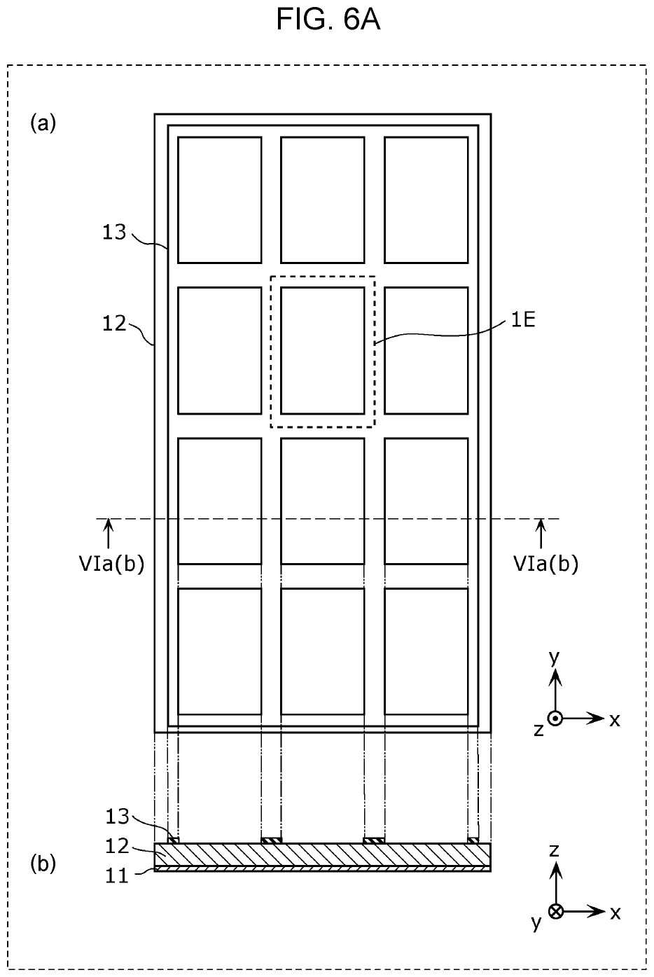

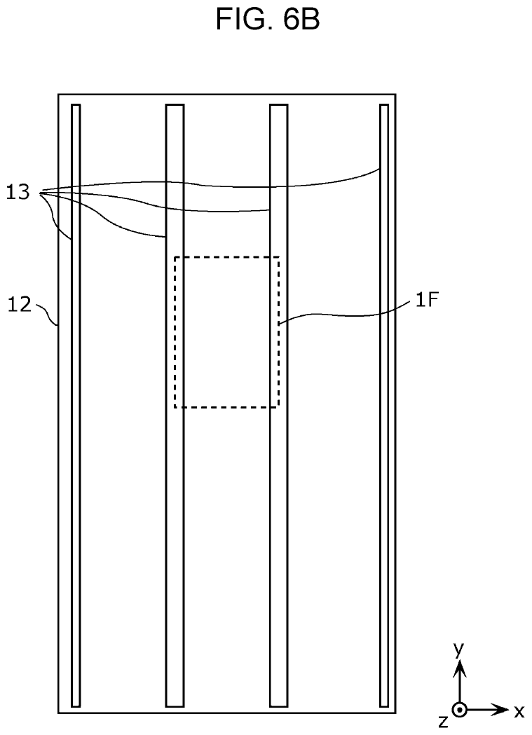

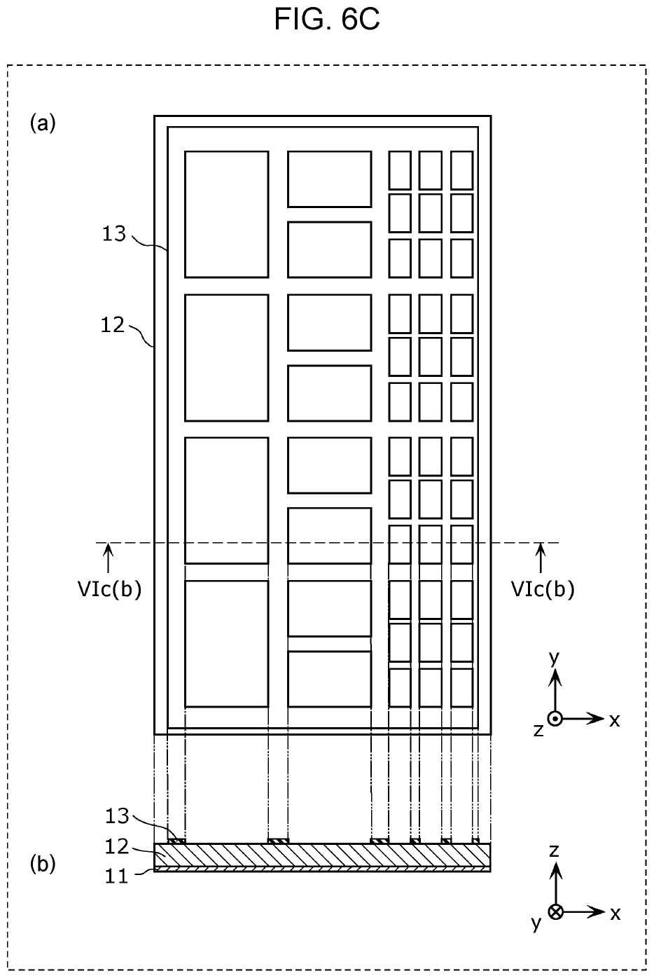

FIGS. 6A, 6B, and 6C are schematic views showing examples of laminated combinations of a collector 11, an electrode active material layer 12, and an insulating layer 13. (a) of FIG. 6A is a schematic top view showing an example of a laminated combination of a collector 11, an electrode active material layer 12, and an insulating layer 13, and (b) of FIG. 6A is a schematic cross-sectional view taken along line VIa(b)-VIa(b) in (a) of FIG. 6A. For example, as shown in FIG. 6A, the insulating layer 13 is formed into a grating shape. Further, FIG. 6B is a schematic top view showing another example of a laminated combination of a collector 11, an electrode active material layer 12, and an insulating layer 13. Although FIG. 6B does not illustrate a cross-sectional view, the laminated combination of the collector 11, the electrode active material layer 12, and the insulating layer 13 shown in FIG. 6B has a cross-sectional structure similar to that of (b) of

FIG. 6A. As shown in FIG. 6B, the insulating layer 13 may be formed into a striped shape. By thus laminating the insulating layer 13 into a comparatively simple shape in plan view, such as a grating shape or a striped shape, having an elongated portion, the insulating layer 13 can be easily formed on top of the electrode active material layer 12. Further, by the insulating layer 13 being divided along a direction parallel with the length of the insulating layer 13 in the after-mentioned cutting step, a battery 50 can be easily formed with the insulating layer 13 formed along ends of the battery 50. In FIGS. 6A and 6B, rectangular regions 1E and 1F indicated by dotted lines are equivalent to the size of one battery 50. Thus, the electrode active material layer 12 and the insulating layer 13 may be laminated on the collector 11 so that a division into a plurality of batteries can be made in a later manufacturing step.

Further, (a) of FIG. 6C is a top view showing still another example of a laminated combination of a collector 11, an electrode active material layer 12, and an insulating layer 13, and (b) of FIG. 6C is a cross-sectional view taken along line VIc(b)-VIc(b) in (a) of FIG. 6C. As shown in FIG. 6C, a grating-shaped insulating layer 13 of multiple types of pattern (e.g. grating space) may be formed on top of the electrode active material layer 12.

By the insulating layer 13 being thus laminated into a grating shape or a striped shape and divided along a direction parallel with the length of the grating shape or the striped shape of the insulating layer 13 in the after-mentioned cutting step, a plurality of batteries 50 of the same shape or different shapes can be simultaneously manufactured. This brings about improvement in efficiency in the manufacture of batteries 50.

The electrode active material layer 12 is formed, for example, by using a wet coating method. The use of the wet coating method makes it possible to easily laminate the electrode active material layer 12 on the collector 11. Usable examples of the wet coating method include, but are not limited to, coating methods such as a die coating method, a doctor blade method, a roll coater method, a screen printing method, and an inkjet method.

In a case where the wet coating method is used, a paint-making step is executed in which a slurry is obtained by appropriately mixing together the material that forms the electrode active material layer 12 (i.e. the aforementioned material of the positive-electrode active material layer or and the negative-electrode active material layer) and a solvent.

As the solvent for use in the paint-making step, a generally known solvent that is used in fabricating a generally known all solid battery (e.g. a lithium-ion all-solid battery) may be used.

The slurry, obtained in the paint-making step, of each layer is applied over the collector 11 so that the electrode active material layer 12 is overlaid. The application of the slurry may be followed, for example, by the execution of a heat treatment that removes the solvent and the binder material. Further, the application of the slurry may be followed, if necessary, by the execution a high-pressure press process that accelerates the filling of the material. This causes the electrode active material layer 12 to be formed on top of the collector 11.

As a method for forming the insulating layer 13, there are a variety of possible processes; however, from the point of view of mass-producibility, for example, an application process is used. For example, paint obtained by dispersing an insulating substance (e.g. a metal oxide) into a solvent is applied onto the electrode active material layer 12 as a material of the insulating layer 13 by a high-accuracy coating method such as a gravure roll method or an inkjet method in a continuous process such as a roll-to-roll process, and the solvent is evaporated by drying, whereby the insulating layer 13 can be obtained. This makes it possible to thinly laminate the insulating layer 13, so that the insulating layer 13 thus formed is a thin layer of uniform thickness. Therefore, in a case where a high-pressure press process is performed in laminating another layer in the second laminating step, the layer is hardly affected by the insulating layer 13 and easily uniformly compressed. Further, by using such a high-accuracy coating method, the accuracy of the area of the electrode active material layer 12 that is substantially effective as an electrode is increased.

In a case where resin is used as the material of the insulating layer 13, a solution obtained by dissolving or dispersing resin may be applied onto the electrode active material layer 12, or ultraviolet-curable resin or thermosetting resin may be applied onto the electrode active material layer 12 and subjected to a curing process. It should be noted that the formation of the insulating layer 13 is not limited to a continuous process such as a roll-to-roll process, but may be a batch process for forming the insulating layer 13 for each single collector 11.

As the solvent for use in the formation of the insulating layer 13, a common organic solvent, aqueous solvent, or other solvents in which a metal oxide or resin is dispersed or dissolved may be used.

### (2) Second Laminating Step

Next, the second laminating step is described. In the second laminating step, on a laminated combination of the collector 11 and the electrode active material layer 12 and the insulating layer 13 laminated on the collector 11 in the first laminating step, a solid electrolyte layer 30 and a counter-electrode active material layer 22 are laminated in this order such that the solid electrolyte layer 30 covers the electrode active material layer 12 and the insulating layer 13, whereby a power-generating element 40 in which the electrode active material layer 12, the solid electrolyte layer 30, and the counter-electrode active material layer 22 are laminated in this order is formed on top of the collector 11. Further, in the second laminating step, a covering structure is formed in which the solid electrolyte layer 30 covers the electrode active material layer 12 and the insulating layer 13. Specifically, the solid electrolyte layer 30 and the counter-electrode active material layer 22 are laminated in this order on top of each other over the laminated combination of the collector 11, the electrode active material layer 12, and the insulating layer 13 (steps S14 and S15 of FIG. 5). For example, over the laminated combination of the collector 11, the electrode active material layer 12, and the insulating layer 13, the solid electrolyte layer 30 is laminated so as to cover the electrode active material layer 12 and the insulating layer 13; furthermore, the counter-electrode active material layer 22 is laminated. Furthermore, if necessary, a high-pressure press process is performed on the solid electrolyte layer 30 and the counter-electrode active material layer 22, which were laminated in steps S14 and S15 (step S16 of FIG. 5). Further, if necessary, a heat treatment is performed on the solid electrolyte layer 30 and the counter-electrode active material layer 22, which were laminated in steps S14 and S15, whereby a power-generating element 40 provided between the electrode active material layer 12 and the solid electrolyte layer 30 is formed. This gives a laminated polar plate in which the power-generating element 40 is laminated on top of t the collector 11.

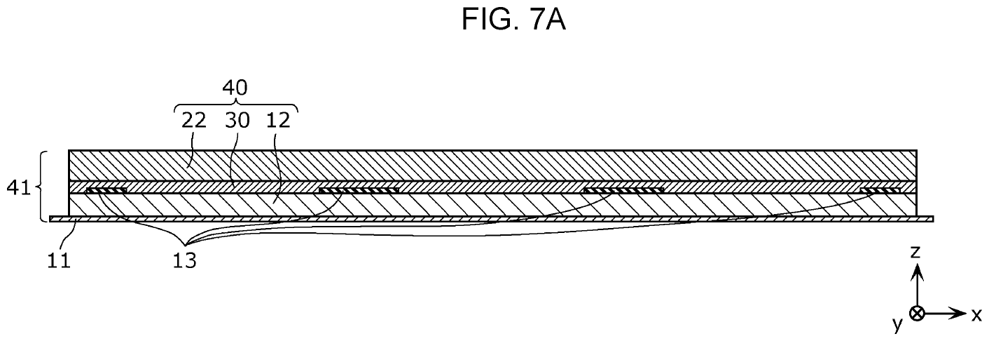

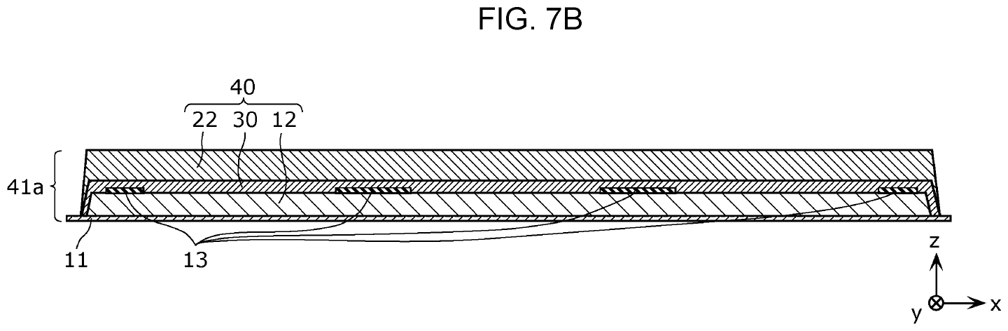

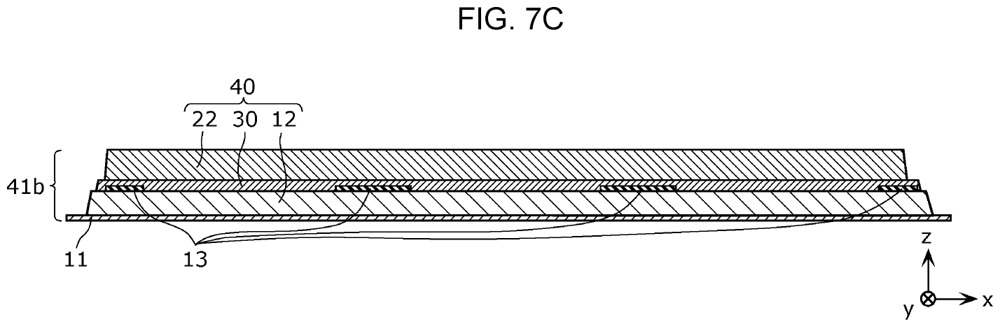

FIGS. 7A, 7B, and 7C are schematic cross-sectional views showing examples of laminated polar plates according to the present embodiment. In a laminated polar plate 41, as shown in FIG. 7A, a power-generating element 40 obtained by laminating an electrode active material layer 12, a solid electrolyte layer 30, and a counter-electrode active material layer 22 in this order is laminated on top of a collector 11. Further, in the power-generating element 40, the insulating layer 13 is laminated on top of the electrode active material layer 12. The laminated polar plate 41 is formed such that the electrode active material layer 12, the solid electrolyte layer 30, and the counter-electrode active material layer 22 are identical in area and position to one another in plan view. Further, the counter-electrode active material layer 22 has its upper surface exposed.

The structure of the laminated polar plate 41 is not limited to this example. For example, as shown in FIG. 7B, a laminated polar plate 41a is formed such that a solid electrolyte layer 30 covers side and upper surfaces of an electrode active material layer 12 and a counter-electrode active material layer 22 covers side and upper surfaces of the solid electrolyte layer 30. This reduces the occurrence of a short circuit due to contact between the electrode active material layer 12 and the counter-electrode active material layer 22 in the second laminating step, as the side and upper surfaces of the electrode active material layer 12 are covered with the solid electrolyte layer 30.

Further, for example, as shown in FIG. 7C, a laminated polar plate 41b is formed such that an electrode active material layer 12 is smaller in area than a solid electrolyte layer 30 in plan view and the solid electrolyte layer 30 is smaller in area than a counter-electrode active material layer 22 in plan view. Further, in a plan view, the counter-electrode active material layer 22 is located within the solid electrolyte layer 30, and the solid electrolyte layer 30 is located within the electrode active material layer 12. Since the counter-electrode active material layer 22 is designed to be located within the solid electrolyte layer 30, the solid electrolyte layer 30 reduces the occurrence of a short-circuit due to contact between the electrode active material layer 12 and the counter-electrode active material layer 22 even if the counter-electrode active material layer 22 is laminated with a misalignment in plan view.

A laminated polar plate in the present embodiment may be a structure of any of the laminated polar plates 41, 41a, and 41b, or a structure other than the laminated polar structures 41, 41a, and 41b will do, provided such a structure is a structure in which a power-generating element 40 including a structure in which an insulating layer 13 is laminated on top of an electrode active material layer 12 is laminated on top of a collector 11.

The solid electrolyte layer 30 and the counter-electrode active material layer 22, which constitute the power-generating element 40, are formed in sequence, for example, by using a wet coating method that is similar to that used in forming the electrode active material layer 12.

In a case where the wet coating method is used, a paint-making step is executed in which slurries are obtained separately by appropriately mixing together each of the materials that form the solid electrolyte layer 30 and the counter-electrode active material layer 22 (i.e. each of the aforementioned materials of the solid electrolyte layer 30, the positive-electrode active material layer, and the negative-electrode active material layer) and a solvent.

The slurries, obtained in the paint-making step, of the respective layers are applied over the electrode active material layer 12 and the insulating layer 13 on top of the collector 11. This layered coating is executed in the order of the solid electrolyte layer 30 and then the counter-electrode active material layer 22. In so doing, the overlaying of a layer being overlaid first may be followed by the overlaying of a next layer, or the overlaying of the next layer may be started during the overlaying of the layer being overlaid first. That is, steps S14 and S15 may be concurrently executed. The slurries of the respective layers are sequentially applied, and after all layers have been applied, a heat treatment that removes the solvents and the binder materials and a high-pressure press process that accelerates the filling of the materials of the respective layers are executed, for example. It should be noted that the heat treatment and the high-pressure press process may be executed each time a layer is overlaid. That is, step S16 may be executed between steps between steps S14 and S15. In the overlaying of the solid electrolyte layer 30 and the counter-electrode active material layer 22, the heat treatment and the high-pressure press process may be executed all at once after all two layers have been overlaid. Further, the high-pressure press process involves the use of, for example, a roll press, a flat-plate press, or other presses. It should be noted that at least one of the heat treatment and the high-pressure press process may not be performed.

Performing a layered coating method in this way makes it possible to improve the bondability of the interface between each of the layers, namely the collector 11, the electrode active material layer 12, the insulating layer 13, the solid electrolyte layer 30, and the counter-electrode active material layer 22, and another and reduce interface resistance, and also makes it possible to improve the bondability between the powder materials used in the electrode active material layer 12, the solid electrolyte layer 30, and the counter-electrode active material layer 22 and reduce grain boundary resistivity. That is, favorable interfaces are formed between each of the layers of the power-generating element 40 and another and between each of the powder materials contained in the respective layers and another.

It should be noted that the first and second laminating steps may be performed in a series of continuous processes such as roll-to-roll processes.

### (3) Cutting Step and Third Laminating Step

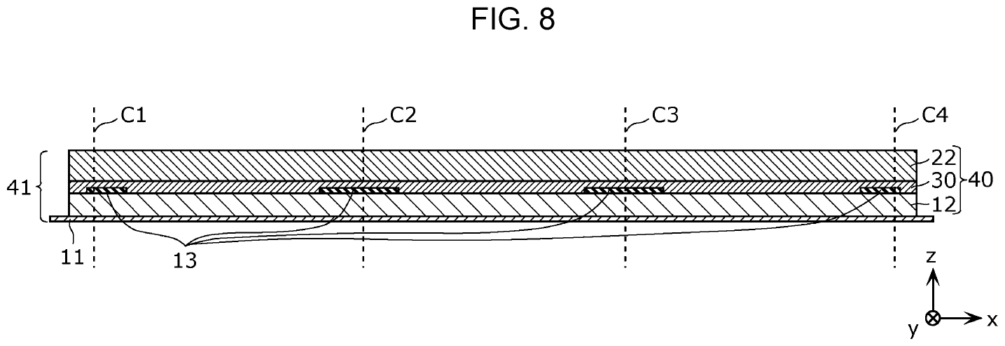

Next, the cutting step and the third laminating step are described. FIG. 8 is a diagram for explaining the cutting step of the method for manufacturing a battery according to the present embodiment. In the cutting step, a laminated combination of the collector 11 and the power-generating element 40 formed in the first and second laminating steps, i.e. the laminated polar plate 41, 41a, or 41b, is cut in the direction of laminating at a position where the insulating layer 13 is divided (step S17 of FIG. 5). As shown in FIG. 8, the laminated polar plate 41 is cut with a blade, laser light, or other devices at the positions of dashed lines C1, C2, C3, and C4 where the insulating layer 13 is disposed. At the positions of the dashed lines C1, C2, C3, and C4, the collector 11, the electrode active material layer 12, the insulating layer 13, the solid electrolyte layer 30, and the counter-electrode active material layer 22 are laminated in this order, and they are collectively cut. This makes it unnecessary to laminate the layers of the power-generating element 40 in shapes into which they have been cut, thus making it possible to easily manufacture batteries 50. For example, in a case where the insulating layer 13 is laminated in a grating shape or a striped shape in plan view, such as that show in FIG. 6A, 6B, or 6C, having an elongated portion, the laminated combination of the collector 11 and the power-generating element 40 is cut along a direction parallel with the length of the grating shape or the striped shape of the insulating layer 13. This gives batteries 50 having the insulating layer 13 located at all ends facing cut surfaces of the batteries 50 thus manufactured.

Next, in the third laminating step, after the laminated polar plate 41 has been cut in the cutting step, a collector 21 is laminated as an additional collector on a surface of the power-generating element 40 of the laminated polar plate 41 that faces away from the collector 11 (i.e. a surface of the power-generating element 40 perpendicular to the direction of laminating on which the collector 11 is not laminated) (step S18 of FIG. 5). Specifically, the collector 21 is bonded by a press process or other processes to the exposed upper surface of the counter-electrode active material layer 22 of the laminated polar plate 41 thus cut. The press process is performed at lower pressure than the high-pressure press process performed in step S16. This gives a battery 50 shown in FIGS. 1 and 2.

It should be noted that the cutting step and the third laminating step may be transposed. That is, before the laminated polar plate 41 is cut in the cutting step, the collector 21 may be laminated first on the surface of the power-generating element 40 of the laminated polar plate 41 that faces away from the collector 11, and then a laminated combination of the laminated polar plate 41 and the collector 21 may be cut in the direction of laminating at the position where the insulating layer 13 is divided. Further, in the third laminating step, a conductive substrate or housing may be laminated as an additional collector instead of the collector 21 on the surface of the power-generating element 40 that faces away from the collector 11.

Thus, the method for manufacturing a battery 50 includes the cutting step of cutting along a position where the collector 11, the electrode active material layer 12, the insulating layer 13, the solid electrolyte layer 30, and the counter-electrode active material layer 22 are laminated. This causes the respective side surfaces of the collector 11, the electrode active material layer 12, the insulating layer 13, the solid electrolyte layer 30, the counter-electrode active material layer 22, and the collector 21 to be exposed at ends in directions perpendicular to the direction of laminating. It should be noted that the side surfaces exposed after cutting may be protected by a sealing member or other members that cover the side surfaces. That is, in a case where the side surfaces are covered with another member such as the sealing member, the side surfaces of all layers may not be exposed.

By thus including the cutting step of cutting along the position where the collector 11, the electrode active material layer 12, the insulating layer 13, the solid electrolyte layer 30, and the counter-electrode active material layer 22 are laminated, ends of the collector 11, the electrode active material layer 12, the insulating layer 13, the solid electrolyte layer 30, the counter-electrode active material layer 22, and the collector 21 in directions perpendicular to the direction of laminating are exposed.

### (4) Effects

As noted above, a method for manufacturing a battery 50 according to the present embodiment includes a first laminating step, a second laminating step, a cutting step, and a third laminating step. In the first laminating step, an insulating layer 13 is laminated on a portion of a surface of an electrode active material layer 12 that faces away from a collector 11. In the second laminating step, a solid electrolyte layer 30 and a counter-electrode active material layer 22 are laminated in this order on a laminated combination of the collector 11, the electrode active material layer 12, and the insulating layer 13 such that the solid electrolyte layer 30 covers the insulating layer 13 and the electrode active material layer 12. In the cutting step, a laminated combination of the collector 11 and a power-generating element 40 is cut in a direction of laminating at a position where the insulating layer 13 is divided. In the third laminating step, before the power-generating element 40 is cut in the cutting step or after the power-generating element 40 has been cut in the cutting step, a collector 21 is laminated on a surface of the power-generating element 40 that faces away from the collector 11.

In this way, the laminated combination of the collector 11 and the power-generating element 40 is cut in the direction of laminating at the position where the insulating layer 13 is divided. This makes it unnecessary to laminate the layers of the power-generating element 40 in shapes into which they have been cut, thus making it possible to easily manufacture the battery 50.

Further, since the laminated combination of the collector 11 and the power-generating element 40, which includes a structure in which the insulating layer 13 is laminated on top of the electrode active material layer 12, is cut in the direction of laminating at the position where the insulating layer 13 is divided, the battery is manufactured with the insulating layer 13 laminated at ends of the electrode active material layer 12 in plan view. Furthermore, since the solid electrolyte layer 30 is laminated so as to cover the insulating layer 13 laminated on the electrode active material layer 12, the electrode active material layer 12, the insulating layer 13, and the solid electrolyte layer 30 are laminated in this order at the ends of the battery 50 thus manufactured. Therefore, even if the solid electrolyte layer 30 delaminates at the ends of the electrode active material layer 12 and the solid electrolyte layer 30, at which delamination tends to occur due to a bonding interface, exposure of the electrode active material layer 12 is reduced, as the insulating layer 13 is exposed. This results in making it hard for damage, a short circuit, or other failures to occur due to contact between the electrode active material layer 12 and another member. This makes it possible to manufacture a highly-reliable battery.

Further, the dimensions of the insulating layer 13 can be determined simply by adjusting cutting position. Therefore, although the presence of the insulating layer 13 inhibits the electrode active material layer 12 and the solid electrolyte layer 30 from giving and receiving lithium ions to and from each other and results in the formation of a region where the electrode active material layer 12 hardly functions as an electrode, the region can be minimized by adjusting the dimensions of the insulating layer 13. This makes it possible to easily manufacture a battery 50 with a high volume energy density.

Further, in a case where the electrode active material layer 12 is a positive-electrode active material layer and the counter-electrode active material layer 22 is a negative-electrode active material layer, the laminating of the insulating layer 13 at the ends of the positive-electrode active material layer prevents metal ions from the positive-electrode active material layer from reaching ends of the solid electrolyte layer 30, so that the function of the positive-electrode active material layer as an electrode at the ends is inhibited. That is, the substantive area of the positive-electrode active material layer is reduced. Further, since the power-generating element 40 is cut in the direction of laminating, the positive-electrode active material layer and the negative-electrode active material layer (counter-electrode active material layer 22) are identical in shape and position to each other in plan view, and are also identical in area to each other in plan view. This causes the positive-electrode active material layer to become narrower in substantive area (area that functions as an electrode) than the negative-electrode active material layer and be located within the negative-electrode active material layer in plan view. This results in suppression of deposition of metal on the negative-electrode active material layer as mentioned above. This brings about further improvement in reliability of the battery 50 to be manufactured.

Further, by being cut in the direction of laminating, the laminated combination of the collector 11 and the power-generating element 40 (e.g. the laminated polar plate 41, 41a, or 41b) is cut to give a battery with the insulating layer 13 laminated at the ends of the electrode active material layer 12. This makes it unnecessary to separately laminate the positive-electrode active material layer and the negative-electrode active material layer for each single cell with the positive-electrode active material layer and the negative-electrode active material layer shaped with a difference in area, thus making it possible to easily manufacture batteries 50 with high production efficiency.

In the absence of the insulating layer 13, the solid electrolyte layer 30 is laminated at the ends of the electrode active material layer 12 too. Therefore, even when the laminated combination of the collector 11 and the power-generating element 40 is cut, a battery is manufactured in which exposure of the electrode active material layer 12 cannot be reduced when the ends of the solid electrolyte layer 30 delaminate and in which there is no substantive difference in area between the electrode active material layer 12 and the counter-electrode active material layer 22. Therefore, although a battery can be easily manufactured, such a battery is low in reliability, and it is hard to employ such a manufacturing method. On the other hand, in the manufacturing method according to the present embodiment, as mentioned above, the laminated combination of the collector 11 and the power-generating element 40 is cut at the position where the insulating layer 13 is divided. Therefore, cutting the laminated combination of the collector 11 and the power-generating element 40 makes it possible to, in addition to easily manufacturing a battery, reduce exposure of the electrode active material layer 12, reduce the area of the electrode active material layer 12 that functions as an electrode, and adjust the area of the insulating layer 13. Such a combination of a first laminating step of laminating an insulating layer 13 on an electrode active material layer 12 and a cutting step of cutting, at a position where the insulating layer 13 is divided, a laminated combination of the collector 11 and a power-generating element 40 including a structure in which the insulating layer 13 is laminated on top of the electrode active material layer 12 makes it possible to easily manufacture a highly-reliable battery with a high volume energy density.

### (5) Other Manufacturing Methods

The method for manufacturing a battery according to the present embodiment is not limited to the aforementioned example but may for example be the following manufacturing method.

First, a collector 11 having a shape shown in FIGS. 1 and 2 is prepared. Then, an application process or other processes are used to laminate an electrode active material layer 12 on top of the collector 11 in a shape shown in FIGS. 1 and 2. Furthermore, an insulating layer 13 is formed in a shape shown in FIGS. 1 and 2 on top of the electrode active material layer 12 laminated on top of the collector 11. A solid electrolyte layer 30 is laminated by layered coating all over the electrode active material layer 12 on which the insulating layer 13 has been formed, whereby an electrode plate is obtained.

Next, a collector 21 having a shape shown in FIGS. 1 and 2 is prepared. Then, a counter-electrode active material layer 22 and a solid electrolyte layer 30 are laminated by layered coating in this order on top of each other all over the collector 21, whereby a counter-electrode plate is obtained.

Next, the electrode plate thus obtained and the counter-electrode plate thus obtained are laminated such that their respective solid electrolyte layers 30 make contact with each other. The laminated body thus laminated is pressed from both sides in the direction of laminating by using a flat-plate press, whereby a battery 50 is obtained.

### Modification 1

The following describes Modification 1 of Embodiment 1. The following describes Modification 1 of Embodiment 1 with a focus on differences from Embodiment 1, and omits or simplifies a description of common features.

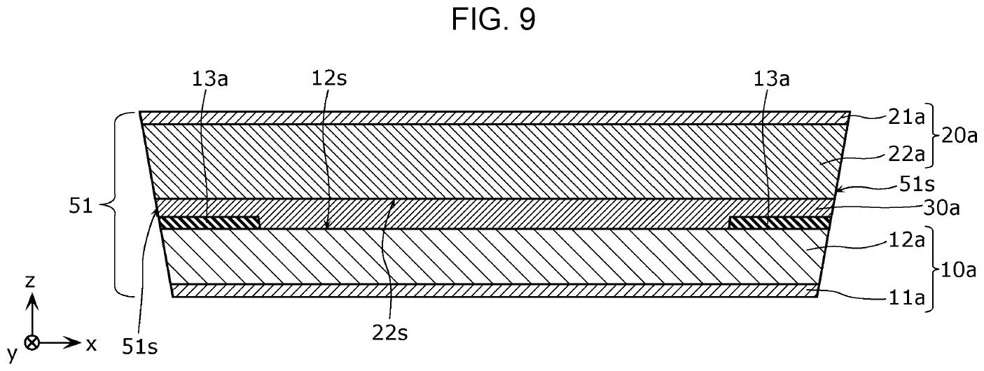

FIG. 9 is a schematic cross-sectional view showing an example of a battery according to the present modification. As shown in FIG. 9, the battery 51 differs from the battery 50 of Embodiment 1 in that the battery 51 has side surfaces inclined with respect to the direction of laminating.

The battery 51 includes an electrode layer 10a, a counter-electrode layer 20a placed opposite to the electrode layer 10a, and a solid electrolyte layer 30a located between the electrode layer 10a and the counter-electrode layer 20a. The battery 51 further includes an insulating layer 13a located between the electrode layer 10a and the solid electrolyte layer 30a.

The electrode layer 10a includes a collector 11a and an electrode active material layer 12a located between the collector 11a and the solid electrolyte layer 30a. The counter-electrode layer 20a includes a collector 21a and a counter-electrode active material layer 22a located between the collector 21a and the solid electrolyte layer 30 and between the collector 21a and the insulating layer 13a. The insulating layer 13a is located at ends of the electrode active material layer 12a in plan view.

A side surface 51s connecting two principal surfaces of the battery 51 that are perpendicular to the direction of laminating is inclined in such a direction with respect to the direction of laminating that the area of the counter-electrode layer 20a is larger than the area of the electrode layer 10a in plan view. In other words, the side surface 51s is inclined in such a direction with respect to the direction of laminating that the width of the counter-electrode layer 20a is larger than the width of the electrode layer 10a in a cross-section obtained by cutting the battery 51 in the direction of laminating. That is, in the battery 51, the area of a principal surface 22s of the counter-electrode active material layer 22a that faces the electrode active material layer 12a is larger than the area of a principal surface 12s of the electrode active material layer 12a that faces the counter-electrode active material layer 22a. Further, when seen from an angle parallel with the direction of laminating, the principal surface 12s is located within the principal surface 22s. Further, in the battery 51, for example, the electrode layer 10a, which includes the electrode active material layer 12a, is a positive-electrode layer including a positive-electrode active material layer, and the counter-electrode layer 20a, which includes the counter-electrode ctive material layer 22a, is a negative-electrode layer including a negative-electrode active material layer. In this case, deposition of metal is suppressed in the battery 51, as the area of the negative-electrode active material layer is larger than the area of the positive-electrode active material layer in plan view.

Further, since, on the side surface 51s, side surfaces of the solid electrolyte layer 30 and the insulating layer 13a too are inclined with respect to the direction of laminating, the exposed surfaces of the solid electrolyte layer 30 and the insulating layer 13a are large, so that the distance between the electrode active material layer 12a and the counter-electrode active material layer 22a on the side surface 51s is long. This makes it hard for the electrode active material layer 12a and the counter-electrode active material layer 22a to make contact with each other, reducing the risk of a short circuit.

Further, all side surfaces 51s of the battery 51 including side surfaces 51s that are not illustrated are inclined with respect to the direction of laminating, so that the area of the principal surface 22s is larger than the area of the principal surface 12s. It should be noted that all side surfaces 51s of the battery 51 do not need to be inclined with respect to the direction of laminating, but at least one side surface 51s needs only be inclined with respect to the direction of laminating.

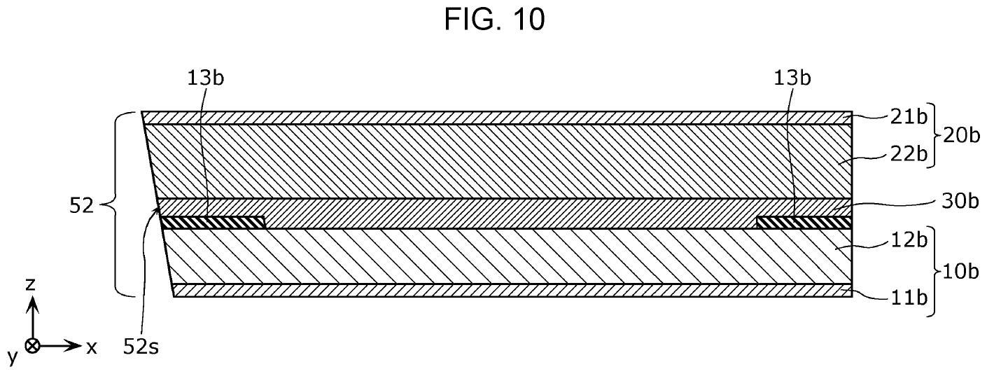

FIG. 10 is a schematic cross-sectional view showing another example of a battery according to the present modification. As shown in FIG. 10, the battery 52 includes an electrode layer 10b, a counter-electrode layer 20b, and a solid electrolyte layer 30b. The battery 52 further includes an insulating layer 13b located between the electrode layer 10b and the solid electrolyte layer 30b. The electrode layer 10b includes a collector 11b and an electrode active material layer 12b. The insulating layer 13b is located at ends of the electrode active material layer 12b in plan view. The counter-electrode layer 20b includes a collector 21b and a counter-electrode active material layer 22b. In the battery 52, one side surface 52s is inclined in such a direction with respect to the direction of laminating that the area of the counter-electrode layer 20b is larger than the area of the electrode layer 10b in plan view.

The batteries 51 and 52 are manufactured, for example, by cutting a battery 50 according to Embodiment 1 in a direction inclined with respect to the direction of laminating. Further, the batteries 51 and 52 may also be manufactured by being cut in a direction inclined with respect to the direction of laminating in the cutting step of the method for manufacturing a battery 50. That is, the side surfaces 51s and 52s may be cut surfaces. In the case of the battery 51, the cut surfaces are trapezoidal, and in the case of the battery 52, the cut surfaces are rectangular.

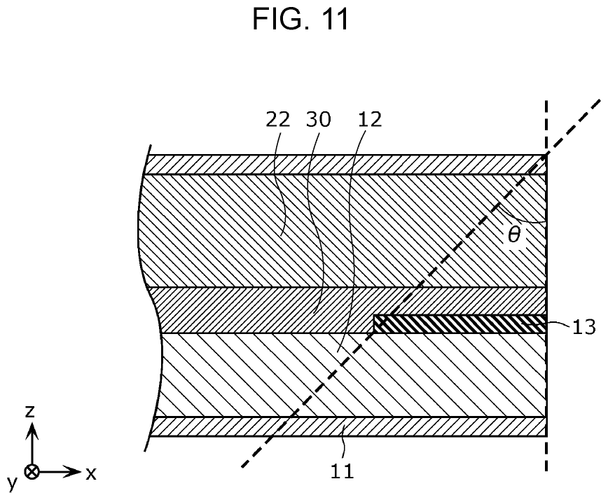

FIG. 11 is a diagram for explaining a cutting step of a method for manufacturing a battery according to the present modification. As shown in FIG. 11, the batteries 51 and 52 are manufactured by being cut in a direction inclined at an angle θ with respect to the direction of laminating in the aforementioned cutting step. The angle θ needs only be determined, for example, from the width of the insulating layer formed and the intended battery characteristics. The angle θ is for example less than 45 degrees. The angle θ may be less than or equal to 45 degrees. In a case where the angle θ is zero degree, the battery 50 is manufactured. For example, if the angle of a cut surface is larger than 45 degrees in a case where the total of the thicknesses of the collector 21, the counter-electrode active material layer 22, and the solid electrolyte layer 30 is 0.1 mm and the width of an insulating layer from a side surface of the battery is 0.1 mm, the insulating layer is removed by cutting, with the result that an effect of the insulating layer is not brought about.

### Embodiment 2

Next, a battery according to Embodiment 2 is described. The battery according to Embodiment 2 is a laminated battery in which single cells are laminated. The following gives a description with a focus on differences from Example 1 described above, and omits or simplifies a description of common features.

### Configuration

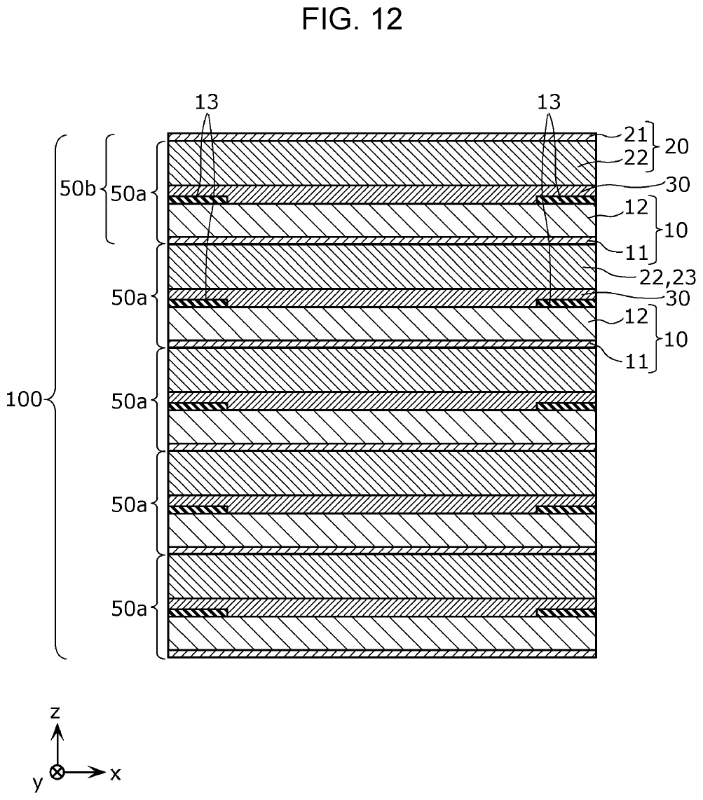

First, a configuration of a battery according to Embodiment 2 is described with reference to the drawings. FIG. 12 is a schematic cross-sectional view showing an example of a battery according to the present embodiment. As shown in FIG. 12, the battery 100 has a structure in which single cells structured not to have the collector 12 of the battery 50 according to Embodiment 1 are laminated.

The battery 100 includes a plurality of batteries 50a and a collector 21. The batteries 50a are each structured to include a counter-electrode layer 23 not having the collector 21 of the counter-electrode layer 20 in the battery 50. That is, the batteries 50a each include an electrode layer 10, a counter-electrode layer 23 placed opposite to the electrode layer 10 and constituted by a counter-electrode active material layer 22, and a solid electrolyte layer 30 located between the electrode layer 10 and the counter-electrode layer 23. The battery 50a further includes an insulating layer 13 located between the electrode layer 10 and the solid elecrolyte layer 30.

In the battery 100, the plurality of batteries 50a are laminated such that the collector 11 of a first one of adjacent batteries 50a and the counter-electrode active material layer 22 of a second one of the adjacent batteries 50a face each other. This makes a structure in which the function of the collector 11 is shared by the adjacent batteries 50a. Further, the collector 21 is laminated on top of the counter-electrode active material layer 22 of the uppermost battery 50a. In this way, the battery 100 serves as a series-laminated battery. This makes it possible to achieve a series-laminated high-voltage battery 100 that exhibits an effect similar to that of the battery 50 according to Embodiment 1.

In the example shown in FIG. 12, the number of batteries 50a that are laminated is 5, but may be larger than or equal to 2 and less than or equl to 4 or may be larger than or equal to 6. The uppermost single cell, namely a battery 50b, is constituted by a battery 50a and the collector 21, and is identical in laminating configuration and shape to the battery 50 according to Embodiment 1.

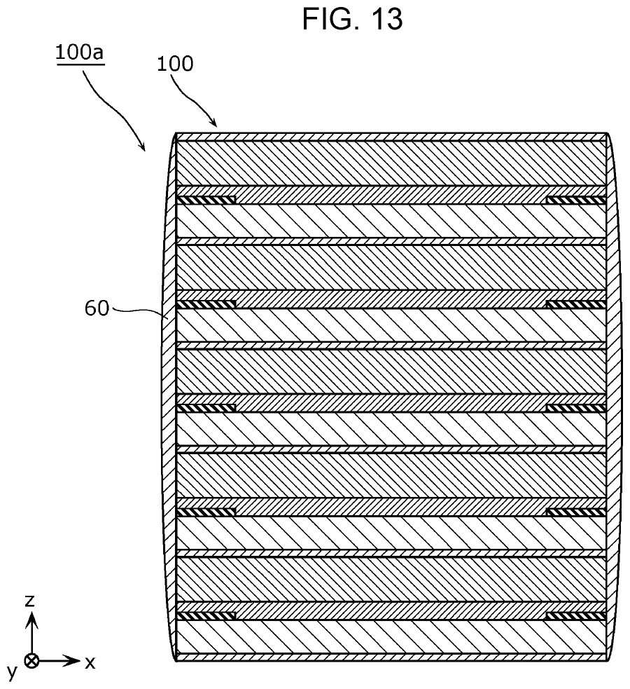

A side surface of the battery 100 is for example a cut surface. Further, the side surface of the battery 100 is a flat surface. In other words, side surfaces of the plurality of batteries 50a and the collector 21 are flush with one another. On the side surface of the battery 100, the layers may be exposed, and a sealing member or other members may be provided. FIG. 13 is a schematic cross-sectional view showing another example of a battery according to the present embodiment. As shown in FIG. 13, the battery 100a has a structure in which the side surface of the battery 100 is covered with a sealing member 60. That is, the side surfaces of the layers that constitute the battery 100a are covered with the sealing member 60. This prevents the side surfaces of the layers from being exposed, thus bringing about increase in strength of the battery 100a and improvement in reliability of the battery 100a.

The sealing member 60 of the battery 100a is formed by placing the battery 100 so that the side surface of the battery 100 faces upward and applying a sealing member to the side surface from above with a dispenser or other devices. As a material of the sealing member 60, a material of a sealing member for use in a generally known battery (e.g. a lithium-ion all-solid battery) may be used.

### Manufacturing Method

The following describes a method for manufacturing a battery according to the present embodiment. It should be noted that the following method for manufacturing a battery 100 is just an example, and the method for manufacturing a battery 100 is not limited to the following example.

As is the case with the method for manufacturing a battery 50, the method for manufacturing a battery 100 includes an first laminating step, a second laminating step, a cutting step, and a third laminating step. The following describes each of the steps in detail.

### (1) First Laminating Step

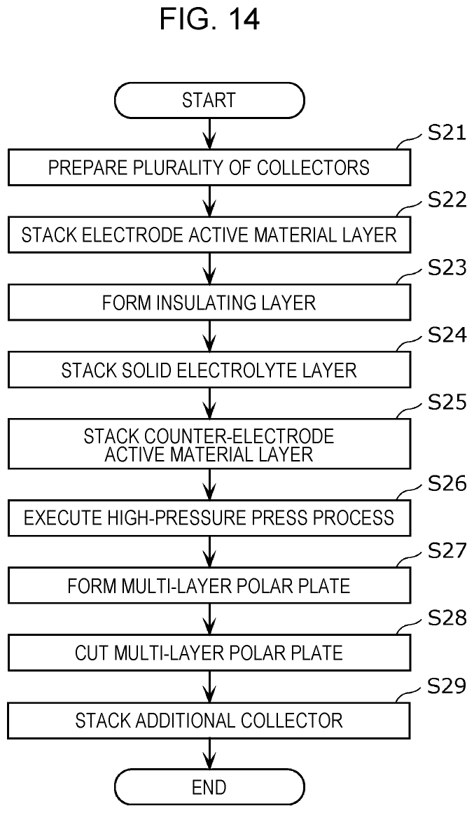

First, the first laminating step is described. FIG. 14 is a flow chart for explaining a method for manufacturing a battery according to the present embodiment.

In the first laminating step, first, a plurality of collectors 11 are prepared (step S21 of FIG. 14). Then, an electrode active material layer 12 is laminated only on one surface of each of the plurality of collectors 11 thus laminated (step S22 of FIG. 14). Then, an insulating layer 13 is laminated on a surface of the electrode active material layer 12 that faces away from the collector 11 (step S23 of FIG. 14). Steps S21, S22, and S23 may involve the use of methods which are similar to those used in the aforementioned steps S11, S12, and S13. This gives a plurality of laminated combinations, such as those shown in FIGS. 6A, 6B, and 6C, of a collector 11, an electrode active material layer 12, and an insulating layer 13.

### (2) Second Laminating Step

Next, the second laminating step is described. In the manufacturing method according to the present embodiment, the second laminating step includes a laminated body forming step and a laminated body laminating step. In the laminated body forming step, a solid electrolyte layer 30 and a counter-electrode active material layer 22 are laminated on a laminated combination of each of the plurality of collectors 11, the electrode active material layer 12, and the insulating layer 13 such that the solid electrolyte layer 30 covers the electrode active material layer 12 and the insulating layer 13, whereby a plurality of laminated polar plates (e.g. laminated polar plates 41, 41a, or 41b shown in FIGS. 7A, 7B, and 7C) each including a collector 11 and a power-generating element 40 laminated on top of the collector 11 are formed. Specifically, a solid electrolyte layer 30 and a counter-electrode active material layer 22 are laminated in this order on top of each other over a laminated combination of each of the plurality of collectors 11, the electrode active material layer 12, and the insulating layer 13 such that the solid electrolyte layer 30 covers the electrode active material layer 12 and the insulating layer 13 (steps S24 and S25 of FIG. 14). Furthermore, if necessary, a high-pressure press process is performed on each of the solid electrolyte layer 30 and the counter-electrode active material layer 22, which were laminated in steps S24 and S25 (step S26 of FIG. 14). Further, if necessary, a heat treatment is performed on each of the solid electrolyte layer 30 and the counter-electrode active material layer 22, which were laminated in steps S24 and S25. The high-pressure press process and the heat treatment may also be performed on the electrode active material layer 12, which was laminated in step S22 in the first laminating step. Steps S24, S25, and S26 may involve the use of methods which are similar to those used in the aforementioned steps S14, S15, and S16.

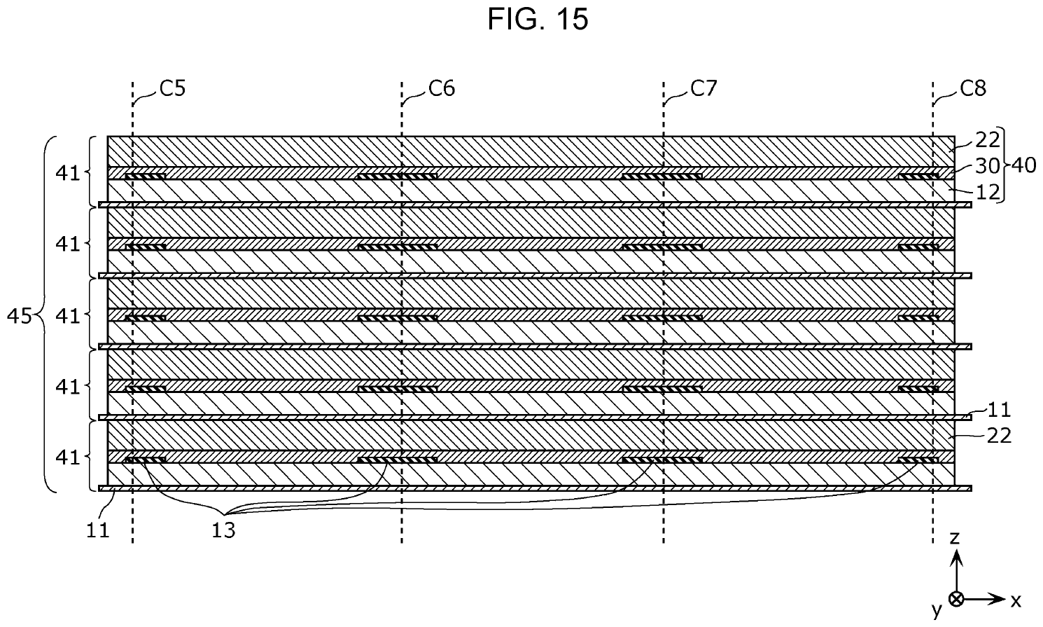

Next, in the laminated body laminating step, the plurality of laminated polar plates formed in the laminated body forming step are laminated such that there is an overlap in position between the insulating layer 13 of each of the laminated polar plates and the insulating layer 13 of another of the laminated polar plates in plan view (step S27 of FIG. 14). This forms a multi-layer polar plate in which the plurality of laminated polar plates are laminated. FIG. 15 is a schematic cross-sectional view showing an example of a multi-layer polar plate according to the present embodiment. FIG. 15 shows a multi-layer polar plate 45 in which laminated polar plates 41 are laminated. As shown in FIG. 15, in the laminated body laminating step, the plurality of laminated polar plates 41 are laminated such that the counter-electrode active material layer 22 of a first one of adjacent laminated polar plates 41 faces the collector 11 of a second one of the adjacent laminated polar plates 41. For example, by performing a press process for pressing, from both sides in the direction of laminating, the plurality of laminated polar plates 41 thus laminated, the plurality of laminated polar plates 41 are bonded to one another to form the multiple-layer polar plate 45. In the multi-layer polar plate 45, the collector 11 of an upper one of adjacent laminated polar plates 41 and the counter-electrode active material layer 22 of a lower one of the adjacent laminated plates 41 are in contact with each other.

In a case where the electrode active material layers 12, the solid electrolyte layers 30, and the counter-electrode active material layers 22 have been subjected to a high-pressure press process in forming the laminated polar plates 41, a high-pressure press is not needed in a press process in forming the multi-layer polar plate 45. For example, the pressure of the press process for bonding the laminated polar plates 41 to one another in step S27 is lower than the pressure of the high-pressure press process in step S26. This makes it possible to form the multi-layer polar plate 45 without fracturing interfaces formed in the first laminated body forming step.

### (3) Cutting Step and Third Laminating Step

Next, the cutting step and the third laminating step are described. In the cutting step, the multi-layer polar plate 45, i.e. a group of laminated combinations of a collector 11 and a power-generating element 40 formed in the second laminating step, is cut in the direction of laminating at a position where the insulating layers 13 are divided (step S28 of FIG. 14). As shown in FIG. 15, the multi-layer polar plate 45 is cut with a blade, laser light, or other devices, for example, at the positions of dashed lines C5, C6, C7, and C8 where the insulating layers 13 are disposed. At the positions of the dashed lines C5, C6, C7, and C8, the plurality of laminated polar plates 41 are laminated, and they are collectively cut. Thus, collectively cutting the plurality of laminated polar plates 41 makes it unnecessary to manufacture and laminate single cells in shapes into which they have been cut, thus significantly reducing the number of times the power-generating elements 40 are laminated on top of the collectors 11 in the first and second laminating steps. This makes it possible to efficiently manufacture a laminated battery.

Next, in the third laminating step, after the multi-layer polar plate 45 has been cut in the cutting step, a collector 21 is laminated as an additional collector on a surface of a power-generating element 40 of the multi-layer polar plate 45 that faces away from a collector 11 (step S29 of FIG. 14). Specifically, in the multi-layer polar plate 45 thus cut, the collector 21 is bonded by a press process or other processes to a surface of the power-generating element 40 of a laminated polar plate 41 that faces away from the collector 11. This laminated polar plate 41 is one of the plurality of laminated polar plates 41 whose power-generating element 40 has a surface that faces away from the collector 11 and on which another laminated polar plate 41 is not laminated. In the example shown in FIG. 15, the collector 21 is bonded on top of the counter-electrode active material layer 22, whose upper surface is exposed, of the uppermost laminated polar plate 41. This gives a battery 100 shown in FIG. 12.

It should be noted that the cutting step and the third laminating step may be transposed. That is, before the multi-layer polar plate 45 is cut in the cutting step, the collector 21 may be laminated first on a surface of the power-generating element 40 that faces away from a collector 11, and then a laminated combination of the multi-layer polar plate 45 and the collector 21 may be cut in the direction of laminating at the position where the insulating layers 13 are divided.

Thus, using the method for manufacturing a battery according to the present embodiment makes it possible to manufacture a series-laminated high-voltage battery 100.

### Modification 1

The following describes Modification 1 of Embodiment 2. The following describes Modification 1 of Embodiment 2 with a focus on differences from Embodiments 1 and 2, and omits or simplifies a description of common features.

A method for manufacturing a battery according to the present modification is described. The method for manufacturing a battery according to the present modification differs from the method for manufacturing a battery according to Embodiment 2 in that a multi-layer polar plate having a structure in which electrode active material layers 12 are laminated on both surfaces, respectively, of a collector 11 is formed.

First, in the first laminating step, combinations of an electrode active material layer 12 and an insulating layer 13 are laminated on both surfaces, respectively, of a collector 11. The insulating layers 13 laminated on both surfaces are identical in position in plan view. The method for laminating the electrode active material layers 12 and the insulating layers 13 on the collector 11 may involve the use of methods that are similar to those used in the aforementioned steps S11 and S12. For example, an electrode active material layer 12 and an insulating layer 13 are laminated over a surface of a laminated combination, such as that shown in FIG. 6A, 6B, or 6C, of a collector 11, an electrode active material layer 12, and an insulating layer 13 on which an electrode active material layer 12 and an insulating layer 13 are not laminated.

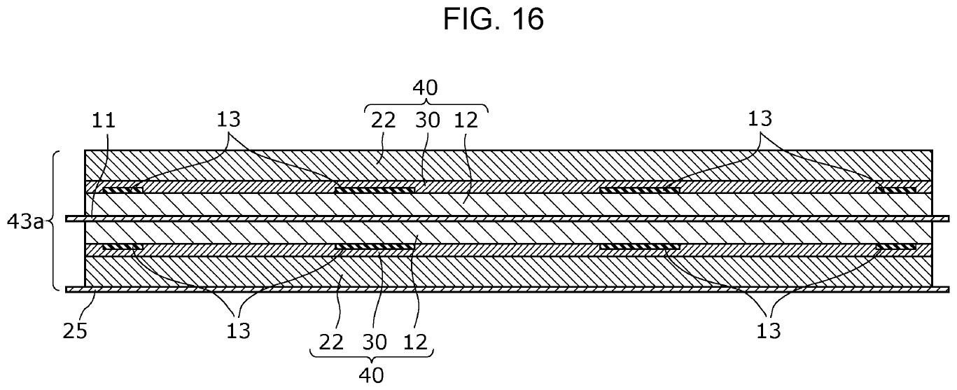

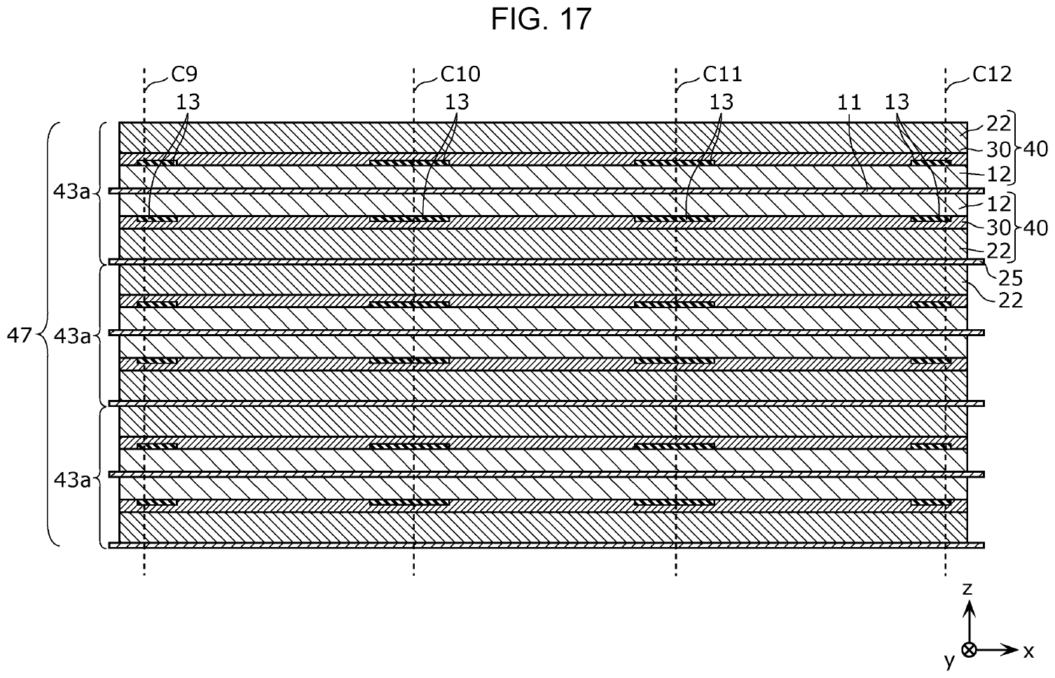

Next, the second laminating step is executed. FIG. 16 is a schematic cross-sectional view showing an example of a laminated polar plate according to the present modification. FIG. 17 is a schematic cross-sectional view showing an example of a multi-layer polar plate according to the present modification. First, a laminated body including a collector 11 and power-generating elements 40 laminated on both surfaces, respectively, of the collector 11 is formed by laminating a solid electrolyte layer 30 and a counter-electrode active material layer 22 by layered coating in this order on each of both surfaces of the collector 11, over both surfaces, respectively, of which the electrode active material layers 12 and the insulating layers 13 are laminated, such that the solid electrolyte layers 30 cover the electrode active material layers 12 and the insulating layers 13. In the laminating of the solid electrolyte layers 30 and the counter-electrode active material layers 22, the layers may be sequentially overlaid separately for each one surface of the collector 11, or layers of the same type may be simultaneously overlaid on both surfaces, respectively, of the collector 11. A laminated polar plate 43a shown in FIG. 16 is formed by laminating the resulting laminated body on a collector 25. In the laminated polar plate 43a, a covering structure is formed in which the solid electrolyte layer 30 covers the electrode active material layer 12 and the insulating layer 13.

The laminating of the solid electrolyte layer 30 and the counter-electrode active material layer 22 of the laminated polar plate 43a may involve the use of methods that are similar to those used in the aforementioned steps S14 and S15. Furthermore, if necessary, a high-pressure press process that is similar to step S16 is performed on each of the electrode active material layer 12, the solid electrolyte layer 30, and the counter-electrode active material layer 22 thus laminated. Further, if necessary, a heat treatment is performed on each of the solid electrolyte layer 30 and the counter-electrode active material layer 22 thus laminated.

Next, as shown in FIG. 17, a plurality of the laminated polar plates 43a are laminated such that there is an overlap in position between the insulating layers 13 of each of the plurality of laminated polar plates 43a and the insulating layers 13 of another of the plurality of laminated polar plates 43a. In so doing, the plurality of laminated polar plates 43a are laminated such that the counter-electrode active material layer 22 of a first one of adjacent laminated polar plates 43a faces the collector 25 of a second one of the adjacent laminated polar plates 43a. The laminated polar plates 43a thus laminated are pressed from both sides in the direction of laminating by a press process, whereby the laminated polar plates 43a are bonded together to form a multi-layer polar plate 47.

The multi-layer polar plate 47 has a structure in which collectors 11, power-generating elements 40, and collectors 25 are laminated. Further, the multi-layer polar plate 47 has a structure in which a collector 11 is sandwiched between two power-generating elements 40 each having a structure in which a solid electrolyte layer 30 is laminated so as to cover an electrode active material layer 12 and an insulating layer 13 and such that a first one of the two power-generating elements 40 is sandwiched between the collector 11 and a collector 25. As will be mentioned in detail later, a collector 21 is laminated on a side of a second one of the two uppermost power-generating elements 40 that faces away from the collector 11.

Although, in the present modification, the number of laminated polar plates 43a that are laminated in the multi-layer polar plate 47 is 3, the number may be larger than or equal to 1 and less than or equal to 2 or may be larger than or equal to 4.

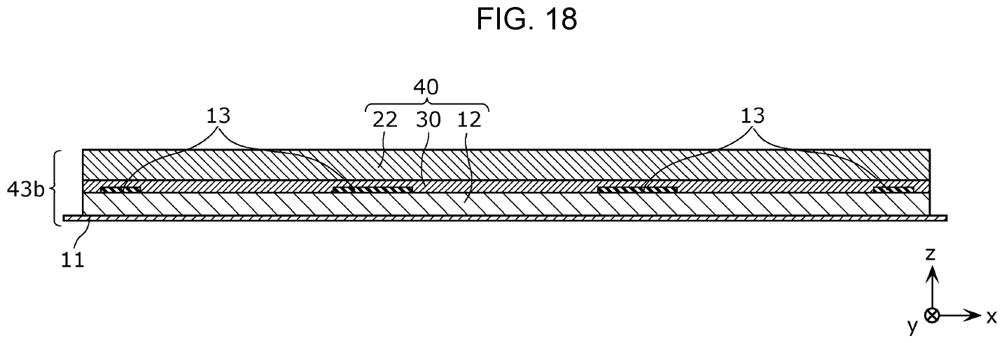

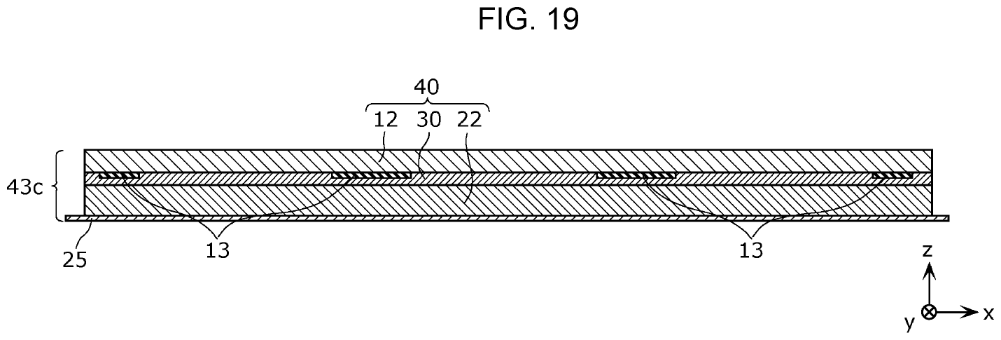

The method for forming the multi-layer polar plate 47 in the first and second laminating steps is not limited to the aforementioned example. FIGS. 18 and 19 are each a schematic cross-sectional view showing another example of a laminated polar plate according to the present modification. In the first and second laminating steps according to the present modification, for example, a laminated polar plate 43b, shown in FIG. 18, that has an insulating layer 13 laminated on an electrode active material layer 12 formed on top of a collector 11 and a laminated polar plate 43c, shown in FIG. 19, that has an insulating layer 13 laminated on an electrode active material layer 12 not formed on top of a collector 11 may be formed. The laminated polar plate 43b is formed, for example, by overlaying a solid electrolyte layer 30 and a counter-electrode active material layer 22 in this order over a collector 11 over one surface of which the electrode active material layer 12 and the insulating layer 13 are laminated. Specifically, a solid electrolyte layer 30 and a counter-electrode active material layer 22 are laminated over one surface of a collector 11 over which an electrode active material layer 12 and an insulating layer 13 are laminated such that the solid electrolyte layer 30 covers the electrode active material layer 12 and the insulating layer 13. In the laminated polar plate 43b, a covering structure is formed in which the solid electrolyte layer 30 covers the electrode active material layer 12 and the insulating layer 13.

Further, in the formation of the laminated polar plate 43c, a power-generating element 40 is formed, for example, by preparing a substrate such as a resin film first and then overlaying an electrode active material layer 12, an insulating layer 13, a solid electrolyte layer 30, and a counter-electrode active material layer 22 in this order over one surface of the substrate. Then, the laminated polar plate 43c is formed by laminating, on top of the counter-electrode active material layer 22 of the power-generating element 40 thus formed, a collector 25 that is identical in planimetric shape to the collector 11 and removing the substrate.

The laminating of the power-generating element 40 of each of the laminated polar plates 43b and 43c may involve the use of methods that are similar to those used in the aforementioned steps S12, S13, S14, and S15. Furthermore, if necessary, a high-pressure press process is performed on each of the electrode active material layer 12, the solid electrolyte layer 30, and the counter-electrode active material layer 22 thus laminated. Further, if necessary, a heat treatment is performed on each of the electrode active material layer 12, the solid electrolyte layer 30, and the counter-electrode active material layer 22 thus laminated.

Next, through the use of the laminated polar plates 43a and 43c thus obtained, a multi-layer polar plate 47 shown in FIG. 17 is formed by alternately laminating the laminated polar plate 43a and a laminated polar plate 43b such that the collector 11 of the laminated polar plate 43b faces the electrode active material layer of the laminated polar plate 43c. In the formation of the multi-layer polar plate 47, the laminated polar plates 43b and 43c are alternately laminated such that there is an overlap in position between the insulating layers 13 of one of the laminated polar plates 43b and 43c and the insulating layers 13 of the other of the laminated polar plates 43b and 43c in plan view. The laminated polar plates 43b and 43c thus laminated are pressed from both sides in the direction of laminating by a press process, whereby the laminated polar plates 43b and 43c are bonded together to form the multi-layer polar plate 47.

In a case where multiple types of laminated polar plate are laminated in combination, as in a case where the laminated polar plates 43b and 43c are alternately laminated, the laminating configuration is not limited to the configuration of the laminated polar plates 43b and 43c. Laminated plate plates may be of any laminating configuration, provided they are configured to be able to form a multi-layer polar plate 47 by being laminated in combination. Alternatively, a laminated polar plate may be formed by three or more separate laminated polar plates.

Next, the cutting step is executed. In the cutting step, the multi-layer polar plate 47, i.e. a combination of the collectors 11, the power-generating elements 40, and the collectors 25 laminated in the first and second laminating steps, is cut in the direction of laminating at a position where the insulating layers 13 are divided. As shown in FIG. 17, the multi-layer polar plate 47 is cut with a blade, laser light, or other devices, for example, at the positions of dashed lines C9, C10, C11, and C12 where the insulating layers 13 are disposed. At the positions of the dashed lines C9, C10, C11, and C12, the plurality of laminated polar plates 43a are laminated, and they are collectively cut.

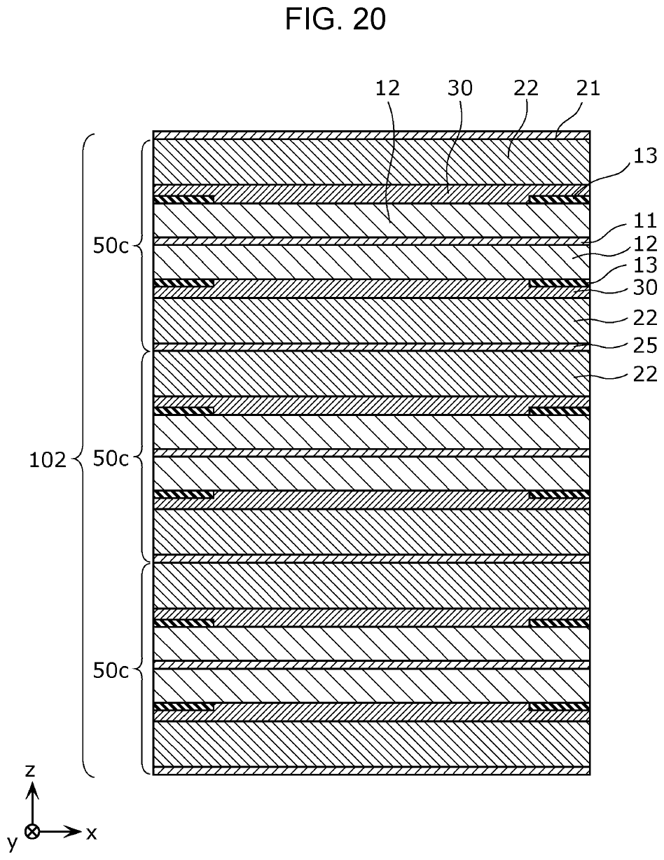

Next, the third laminating step is executed. In the third laminating step, after the multi-layer polar plate 47 has been cut in the cutting step, a collector 21 is laminated as an additional collector on a surface of a power-generating element 40 of the multi-layer polar plate 47 on which a collector 11 is not laminated. Specifically, in the multi-layer polar plate 47 thus cut, the collector 21 is bonded by a press process or other processes to an exposed surface of a power-generating element 40 laminated in the highest or lowest one of the plurality of laminated polar plates 43a. FIG. 20 is a schematic cross-sectional view showing an example of a battery according to the present modification. A battery 102 shown in FIG. 20 is obtained through such a third laminating step.

It should be noted that the cutting step and the third laminating step may be transposed.

As shown in FIG. 20, the battery 102 includes a plurality of batteries 50c and a collector 21. The batteries 50c each include a collector 25, two counter-electrode active material layers 22 located above the collector 25 and placed opposite each other, two solid electrolyte layers 30 located between the two counter-electrode active material layers 22 and placed opposite each other, two electrode active material layers 12 located between the two solid electrolyte layers 30 and placed opposite each other, a collector 11 located between the two electrode active material layers 12, and two insulating layers 13 located between the electrode active material layers 12 and the solid electrolyte layers 30 and laminated at ends of the electrode active material layers 12 in plan view.

In the battery 102, the plurality of batteries 50c are laminated such that the collector 25 of a first one of adjacent batteries 50c and a counter-electrode active material layer 22 of a second one of the adjacent batteries 50c face each other. This results in a structure in which the function of the collector 25 is shared by the adjacent batteries 50c. Further, the collector 21 is laminated on top of a counter-electrode active material layer 22 of the uppermost battery 50c. The battery 102 has a structure in which electrode active material layers 12 are laminated on both surfaces, respectively, of a collector 11 and counter-electrode active material layers 22 are laminated on both surfaces, respectively, of a collector 25. In this way, the battery 102 serves as a parallel-laminated battery. For the purpose of taking out an electric current, the collector 21 and the collectors 25 are electrically connected to each other through leads or other wires, and the collectors 11 are electrically connected to one another through leads or other wires, whereby the battery 102 functions as a parallel-laminated battery. Although, in the example shown in FIG. 20, the number of batteries 50c that are laminated is 3, the number may be larger than or equal to 1 and less than or equal to 2 or may be larger than or equal to 4.

A portion constituted by the collector 21, which is located above the uppermost battery 50c, and the upper counter-electrode active material layer 22, upper solid electrolyte layer 30, upper insulating layer 13, upper electrode active material layer 12, and collector 11 of the uppermost battery 50c is identical in laminating configuration and shape to the battery 50 according to Embodiment 1.

A side surface of the battery 102 is a cut surface formed by the aforementioned manufacturing method. Further, sides surfaces of the plurality of batteries 50b and the collector 21 are flush with one another. That is, one flat surface is formed as a side surface of the battery 102. On a side surface of the battery 102, the layers may be exposed, or a sealing member or other members may be provided.

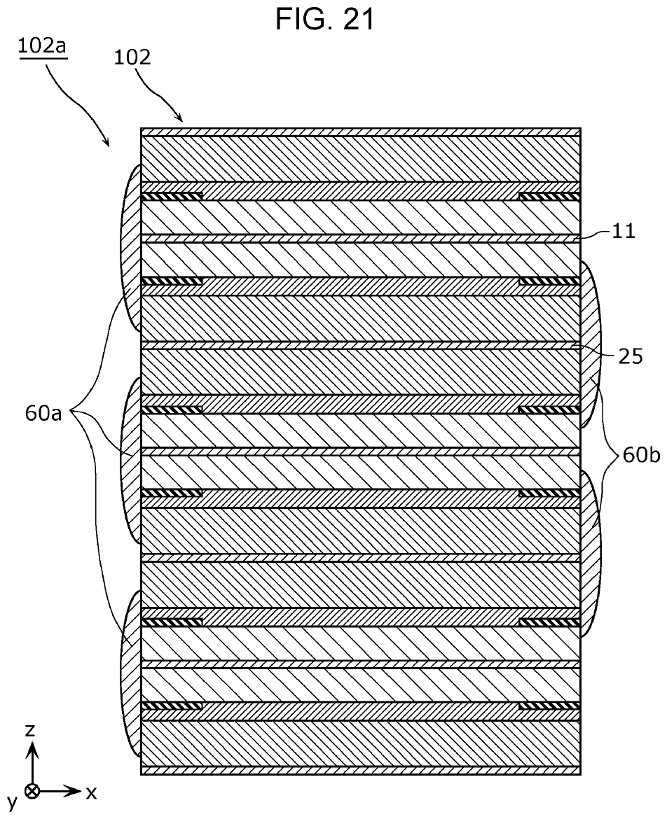

FIG. 21 is a schematic cross-sectional view showing another example of a battery according to the present modification. As shown in FIG. 21, the battery 102a has a structure in which side surfaces of the battery 102 are covered with sealing members 60a and 60b. The side surface of the battery 102 covered with the sealing members 60a and the side surface of the battery 102 covered with the sealing members 60b are placed opposite each other. The side surfaces of the battery 102 are covered. Further, in the battery 102a, the side surfaces of the battery 102a are not entirely covered with the sealing members 60a or 60b. For example, for the purpose of connecting the leads through which to take out electricity, the sealing members 60a do not cover portions of a side surface on which the collectors 25 are exposed, and the sealing members 60b do not cover portions of a side surface on which the collectors 11 are exposed.

Thus, using the method for manufacturing a battery according to the present modification makes it possible to achieve a parallel-laminated high-capacity battery 102 that exhibits an effect similar to that of the battery 50 according to Embodiment 1.

### Embodiment 3

The following describes Embodiment 3. The following describes Embodiment 3 with a focus on differences from Embodiments 1 and 2, and omits or simplifies a description of common features.

FIG. 22 is a cross-sectional view schematically showing a configuration of a battery according to the present embodiment. As shown in FIG. 22, the battery 104 includes a plurality of the batteries 50 according to Embodiment 1, and has a structure in which the plurality of batteries 50 are laminated. The plurality of batteries 50 are laminated such that the electrode layer 10 of a first one of batteries 50 adjacent to each other in the direction of laminating and the counter-electrode layer 20 of a second one of the adjacent batteries 50 face each other. That is, the battery 104 is a series-laminated battery. This makes it possible to achieve a high-voltage battery 104 through the use of batteries 50 according to Embodiment 1.

A side surface of the battery 104 is a flat surface, and in other words, the respective side surfaces of the plurality of batteries 50 are flush with one another. For the purpose of connecting leads or other wires, the plurality of batteries 50 may be laminated out of alignment in a direction perpendicular to the direction of laminating.

The battery 104 is manufactured, for example, by laminating the plurality of batteries 50 such that the electrode layer 10 of a first one of batteries 50 adjacent to each other in the direction of laminating and the counter-electrode layer 20 of a second one of the adjacent batteries 50 face each other. Alternatively, the battery 104 may be manufactured by, before cutting a laminated polar plate 41 (see FIG. 7A), laminating a collector 21 on a side of the power-generating element 40 that faces away from the collector 11, laminating a plurality of laminated combinations of the laminated polar plate 41 and the collector 21, and then cutting the laminated combinations in the direction of laminating at a position where the insulating layers 13 are divided.

Although the batteries 50 are laminated to give a structure in which two collectors 11 and 21 are adjacent to each other, a battery may be free from either of the adjacent collectors 11 and 21.

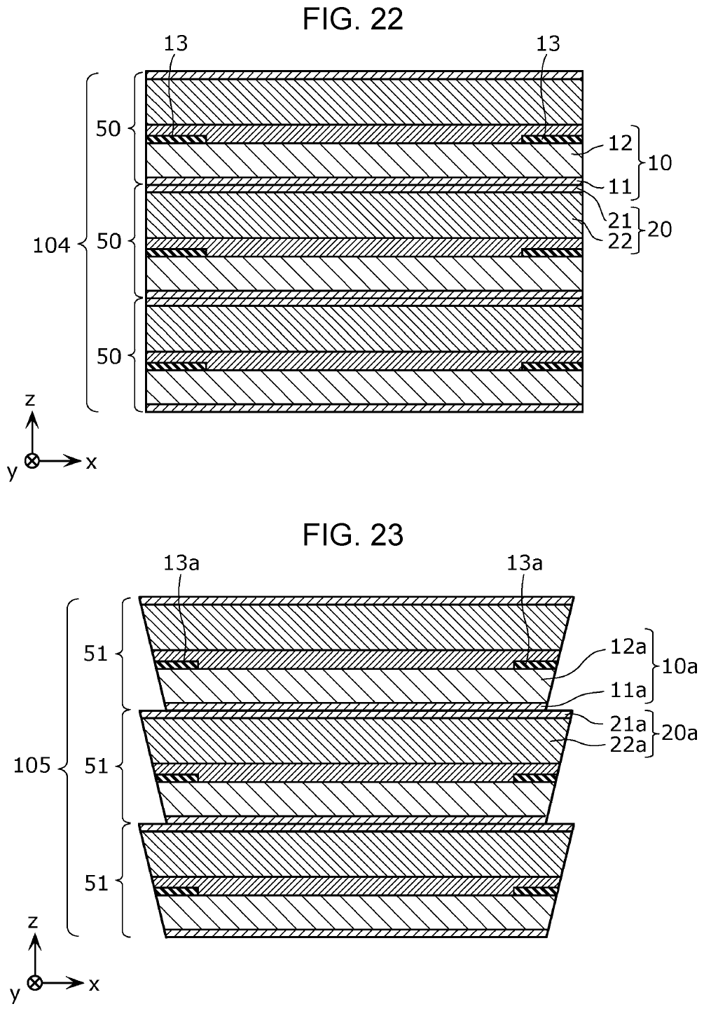

Further, FIG. 23 is a cross-sectional view schematically showing a configuration of another example of a battery according to the present embodiment. As shown in FIG. 23, the battery 105 includes a plurality of the batteries 51 according to Modification 1 of Embodiment 1, and has a structure in which the plurality of batteries 51 are laminated. The plurality of batteries 51 are laminated such that the electrode layer 10a of a first one of batteries 51 adjacent to each other in the direction of laminating and the counter-electrode layer 20a of a second one of the adjacent batteries 51 face each other. That is, the battery 105 is a series-laminated battery. This makes it possible to achieve a high-voltage battery 105 through the use of batteries 51 according to Modification 1 of Embodiment 1.

Although the batteries 104 and 105 are series-laminated batteries, they may be parallel-laminated batteries having a structure in which the electrode layers or counter-electrode layers of adjacent single cells face each other. A parallel-laminated battery can achieve a high-capacity battery.

Thus, laminating the batteries 50 or 51, which are single cells, makes it possible to achieve a high-capacity or high-voltage battery that can exhibit an effect similar to that of the batteries 50 or 51.

### Other Embodiments

In the foregoing, a battery according to the present disclosure and a method for manufacturing the same have been described with reference to embodiments; however, the present disclosure is not intended to be limited to these embodiments. Applications to the present embodiments of various types of modification conceived of by persons skilled in the art and other embodiments constructed by combining some constituent elements of the embodiments are encompassed in the scope of the present disclosure, provided such applications and embodiments do not depart from the spirit of the present disclosure.

Although, in each of the foregoing embodiments, the battery is constituted by a collector, an electrode active material layer, an insulating layer, a solid electrolyte layer, and a counter-electrode active material layer, this is not intended to impose any limitation. For example, a bonding layer or other layers for reducing electric resistance and improving bonding strength may be provided between each of the layers of the battery and another.

Further, in each of the foregoing embodiments, in addition to including the insulating layer located between the electrode active material layer and the solid electrolyte layer at ends of the electrode active material layer in plan view, the battery may further include a second insulating layer located between the counter-electrode active material layer and the solid electrolyte layer at ends of the counter-electrode active material layer in plan view. In this case, the length of the second insulating layer from the outer periphery of the counter-electrode active material layer in plan view may be less than the length of the insulating layer from the outer periphery of the electrode active material layer. This reduces exposure of the counter-electrode active material layer even in a case where ends of the solid electrolyte layer on the counter-electrode active material layer delaminate, and also brings about an effect of making the area of the electrode active material layer substantially smaller than the area of the counter-electrode active material layer, as the second insulating layer is narrower than the insulating layer in plan view.

Further, although, in each of the foregoing embodiments, the insulating layer is in the shape of a frame located on the outer periphery of the electrode layer in plan view, this is not intended to impose any limitation. For example, in the battery, there may be a region on the outer periphery of the electrode layer in plan view where the insulating layer is not provided.

Further, for example, although, in each of the foregoing embodiments, the inner side surface of the insulating layer is in contact with the solid electrolyte layer, this is not intended to impose any limitation. At least a portion of the inner side surface of the insulating layer may be in contact with the electrode active material layer. For example, by adjusting the pressure or other conditions of the high-pressure press process, a portion of the insulating layer is embedded in the electrode active material layer, whereby a battery is manufactured in which at least a portion of the inner side surface of the insulating layer is in contact with the electrode active material layer. Further, for example, by laminating the insulating layer on top of the solid electrolyte layer and then laminating the electrode active material layer in such a manner as to cover the solid electrolyte layer and the insulating layer, a battery is manufactured in which the inner side surface of the insulating layer is in contact with the electrode active material layer.

Further, for example, in each of the foregoing embodiments, the battery may not include a collector on the counter-electrode active material layer in a case where the battery is surrounded by a housing or substrate and a portion of the housing or substrate functions as a collector. In other words, the counter-electrode layer may be constituted by the counter-electrode active material layer.

Further, although, in each of the foregoing embodiments, the collector, the electrode active material layer, the solid electrolyte layer, and the counter-electrode active material layer are identical in shape and position in plan view, this is not intended to impose any limitation. At least one of the collector, the electrode active material layer, the solid electrolyte layer, and the counter-electrode active material layer may be different in shape or position in plan view. For example, the collector may have a terminal that projects from an end of the electrode active material layer in plan view and through which the collector is connected to a lead or other wires. In other words, the collector may have a region disposed outside the electrode active material layer in plan view.

Further, although, in each of the foregoing embodiments, a power-generating element is formed by sequentially laminating the solid electrolyte layer and the counter-electrode active material layer over a laminated combination of the collector, the electrode active material layer, and the insulating layer in the second laminating step, this is not intended to impose any limitation. For example, in the second laminating step, a solid electrolyte layer and a counter-electrode active material layer may be formed by sequentially laminating the solid electrolyte layer and the counter-electrode active material layer over a sheet-like substrate, and the solid electrolyte layer and the counter-electrode active material layer thus formed may be removed from the substrate and laminated on the laminated combination of the collector, the electrode active material layer, and the insulating layer.

Further, the foregoing embodiments are subject, for example, to various changes, substitutions, additions, and omissions in the scope of the claims or the scope of equivalents thereof.

A battery according to the present disclosure may be used as a secondary battery such as an all-solid battery for use, for example, in various types of electronics, automobiles, or other devices.

What is claimed is:

1. A battery comprising:
an electrode layer;
a counter-electrode layer placed opposite to the electrode layer;
a solid electrolyte layer located between the electrode layer and the counter-electrode layer; and
an insulating layer located between the electrode layer and the solid electrolyte layer,
wherein
the electrode layer includes
a collector, and
an electrode active material layer located between the collector and the solid electrolyte layer and between the collector and the insulating layer,
the insulating layer is located at ends of the electrode active material layer in plan view, and
the insulating layer is located in a region where a length of the electrode active material layer from an outer periphery in plan view is less than or equal to 1 mm.

2. The battery according to claim 1, wherein a side surface of the insulating layer and a side surface of the electrode active material layer are flush with each other.

3. The battery according to claim 1, wherein
the electrode layer is a positive-electrode layer, and
the counter-electrode layer is a negative-electrode layer.

4. The battery according to claim 1, wherein the insulating layer contains resin.

5. The battery according to claim 1, wherein the insulating layer contains a metal oxide.

6. The battery according to claim 1, wherein a thickness of the insulating layer is less than or equal to 5 μm.

7. The battery according to claim 6, wherein the thickness of the insulating layer is less than or equal to 2 μm.

8. The battery according to claim 1, wherein
the counter-electrode layer includes a counter-electrode active material layer placed opposite to the electrode active material layer, and
respective side surfaces of the solid electrolyte layer, the collector, the electrode active material layer, the counter-electrode active material layer, and the insulating layer are exposed.

9. The battery according to claim 1, wherein a side surface of the electrode layer, a side surface of the counter-electrode layer, and a side surface of the insulating layer are flush with one another.

10. The battery according to claim 1, wherein
the counter-electrode layer includes a counter-electrode active material layer placed opposite to the electrode active material layer, and
the electrode active material layer and the counter-electrode active material layer are identical in shape and position to each other in plan view.

11. The battery according to claim 1, wherein a side surface of the battery is inclined in such a direction with respect to a direction of laminating that an area of the counter-electrode layer is larger than an area of the electrode layer in plan view.

12. The battery according to claim 1, wherein a side surface of the battery is a cut surface.

13. The battery according to claim 12, wherein a shape of the cut surface is rectangular or trapezoidal.

14. The battery according to claim 1, wherein the insulating layer is in a shape of a frame located on an outer periphery of the electrode active material layer in plan view.

15. The battery according to claim 1, wherein the solid electrolyte layer contains a solid electrolyte having lithium-ion conductivity.
